(19) United States
(12) Patent Application Publication
(10) Pub. No.: US 2025/0094830 A1
(43) Pub. Date: Mar. 20, 2025

(54) FREQUENCY-DOMAIN SIGNAL CLUSTERING

(71) Applicant: ORACLE INTERNATIONAL CORPORATION, Redwood Shores, CA (US)

(72) Inventors: Keyang RU, Kirkland, WA (US); Ruixian LIU, San Diego, CA (US); Kuei-Da LIAO, Newark, CA (US); Guang Chao WANG, San Diego, CA (US); Matthew T. GERDES, Oakland, CA (US); Kenny C. GROSS, Escondido, CA (US)

(21) Appl. No.: 18/370,101

(22) Filed: Sep. 19, 2023

(51) Int. Cl. G06N 5/022

(52) U.S. Cl. CPC G06N 5/022

(57) ABSTRACT

Systems, methods, and other embodiments associated with clustering of time series signals based on frequency domain analysis are described. In one embodiment, an example method includes accessing time series signals to be separated into clusters. The example method also includes determining similarity in the frequency domain among the time series signals. The example method further includes extracting a cluster of similar time series signals from the time series signals based on the similarity in the frequency domain. And, the example method includes training a machine learning model to detect anomalies based on the cluster.

### BACKGROUND

In general, clustering algorithms for gathering collections of time series signals into correlated groups operate in the time domain. Time domain signal clustering algorithms encounter very large miss-clustering errors if the noise on the sensor signals rises to a mere 10-20% noise ratio. And, time-domain clustering algorithms can become completely ineffective for sensors that have inherent noise levels of 50% or more.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a frequency-domain clustering system associated with clustering of time series signals based on frequency domain analysis.

FIG. 2 illustrates one embodiment of a frequency-domain clustering method associated with clustering of time series signals based on frequency domain analysis.

FIG. 3 illustrates one embodiment of a frequency-domain clustering method associated with clustering of time series signals based on frequency domain analysis.

FIG. 4 illustrates a graph of periodograms of selected signals from an example collection of signals.

FIG. 5 illustrates a graph of a cross-power spectral density (CPSD) of a pair of example signals.

FIG. 6 illustrates a graph of selected normalized CPSDs of pairs of signals.

FIG. 7 illustrates a graph of the absolute value of difference (also referred to as absolute error) between a periodogram of a reference signal and selected CPSDs of signal pairs.

FIG. 8 illustrates a plot of cumulative mean absolute error (CMAE) values for the individual signals in an example collection of time series signals.

FIG. 9 illustrates a plot of CMAE values for the individual signals in the example collection, sorted in ascending order of CMAE.

FIG. 10 illustrates a plot of an example mean cumulative function (MCF) for the CMAE values in sorted order.

FIG. 11 illustrates a plot of CMAE values for signals remaining in the collection once a first cluster has been removed from the example collection of time series signals.

FIG. 12 illustrates a plot of sorted CMAE values for the remaining signals.

FIG. 13 illustrates a plot of the MCF of the sorted CMAE values 1205 for the remaining signals.

FIG. 14 illustrates an embodiment of a computing system configured with the example systems and/or methods disclosed.

### DETAILED DESCRIPTION

Systems, methods, and other embodiments are described herein that provide for clustering of time series signals based on frequency domain analysis. In one embodiment, a frequency-domain clustering system determines similarity or dissimilarity of time series signals in the frequency (or spectral) domain, and then the similar time series signals are gathered into a cluster. Previous clustering techniques that operate in the time domain begin to place signals into clusters incorrectly where there is even moderate noise on the signals. But, in one embodiment, the frequency-domain clustering system enables even signals with very high noise ratios to be automatically and accurately placed into clusters.

In one embodiment, the frequency-domain clustering system finds out how similar—that is, how well correlated—time series signals are in the frequency domain. Using the measures of frequency-domain similarity for the signals, the frequency-domain clustering system picks out the signals that are most correlated to be transferred into a cluster. In one embodiment, a change point detection test is used to identify a cluster boundary between the signals that are in the cluster and the signals that are not in the cluster. This process may be repeated, removing additional clusters one-at-a-time from the time series signals until at last the time series signals can no longer be distinguished as dissimilar from each other, producing a final cluster. A machine learning model that is specific to an individual cluster may then be trained to monitor the cluster for anomalous activity, and used to produce alerts when an anomaly appears in one or more signals of the cluster.

For example, the frequency domain clustering system may be presented with a time series database or other collection of time series signals from chemical processing equipment such as may be present in an oil refinery. An oil refinery may have more than one million sensors, and each sensor produces a time series signal of readings. As a practical matter, datasets composed of such large numbers of signals are unlabeled (or incompletely labeled) as to what groups the signals belong to. Sensors employed in chemical processing equipment of an oil refinery such as thermocouples, resistive temperature detectors, piezoelectric vibration detectors, and various chemical sensors used to measure concentrations of gases or fluids may produce signals that include high levels of measurement noise relative to the measured signal. These higher levels of noise on the signals prevents autonomous clustering using previous clustering techniques which operate in the time domain. In one embodiment, the frequency-domain clustering system will automatically identify clusters of sensor signals associated with various components of an oil refinery, despite the high level of measurement noise on the signals. In this way, the frequency-domain clustering system improves the technology of senor monitoring by providing autonomous signal clustering where moderate to severe signal noise would otherwise prevent such autonomous clustering.

### Definitions

As used herein, the terms “time series” and “time series signal” refer to a data structure in which a series of data points or readings (such as observed or sampled values) are indexed in time order. For convenience, a time series signal may be referred to herein simply as a “signal”. In one embodiment, the data points of a time series may be indexed with an index such as a point in time described by a time stamp and/or an observation number. A time series may be considered one “column” or sequence of data points over multiple points in time from one of several sensors used to monitor an asset. For example, a time series is one “column” or sequence of observations over time from one of N variables (such as from one sensor of an aircraft or oil refinery).

As used herein, the term “vector” refers to a data structure that includes a set of data points or readings (such as observed or sampled values) from multiple time series at one particular point in time, such as a point in time described by a time stamp, observation number, or other index. A vector may therefore be considered one “row” of data points sampled at one point in time from all sensors used to monitor an asset. A vector may also be referred to herein as an “observation”. For example, a “vector” is one row of observations from all N variables (such as from multiple (or all) sensors of an aircraft or oil refinery).

As used herein, the term “time series database” refers to a data structure that includes multiple time series that share an index (such as a series of points in time, time stamps, time steps, or observation numbers) in common. In one embodiment, the time series database is one form of a collection of time series signals. From another perspective, the term “time series database” refers to a data structure that includes vectors or observations across multiple time series at a series of points in time, that is, a time series of vectors. As an example, time series may be considered “columns” of a time series database, and vectors may be considered “rows” of a time series database. A time series database is thus one type of a set of time series readings. For example, a database or collection of sensed amplitudes from sensors of an aircraft may be arranged or indexed in order of a recorded time for the amplitudes, thus making a time series database of the sensed amplitudes.

As used herein, the term “residual” refers to a difference or error between a value (such as a measured, observed, sampled, or resampled value) and an estimate, reference, or prediction of what the value is expected to be. In one embodiment, the residual may be an unsigned magnitude of the difference, also referred to as an “absolute error.” For example, a residual may be a difference between an actual, observed value and a machine learning (ML) prediction or ML estimate of what the value is expected to be by an ML model. In one embodiment, a time series of residuals or “residual time series” refers to a time series made up of residual values between a time series of values and a time series of what the values are expected to be.

As used herein, the term “cluster” refers to a subsets of a collection of time series signals that have a relatively high degree of intercorrelation between signals within the subset, and a relatively low degree of intercorrelation with signal outside of the subset (or within other subsets). More generally, signals in a cluster behave more similarly over time to other signals within the cluster than they do with signals outside of the clusters. The clusters can then be monitored for anomalous behavior using ML models that are specifically configured for the individual clusters. In one embodiment, clusters may be discrete, with no overlap or duplication of time series signals from one cluster to another. Where the term “cluster” is used as a verb herein, the term refers to production of the highly intercorrelated subsets of time series signals referred to as clusters.

For example, an aircraft may have an engine, and a hydraulic pump. Time series signals from multiple sensors on the engine may be clustered into a subset of signals that represent correlated behaviors of the engine (e.g., rotation speed, vibration level, temperature, etc.), and time series signals from multiple sensors on the hydraulic pump may be clustered into a subset of signals that represent correlated behaviors of the hydraulic pump. The signals for the engine are more intercorrelated with each other, and less intercorrelated with the signals for the hydraulic pump, and the signals for the hydraulic pump are more intercorrelated with each other, and less intercorrelated with the signals for the engine.

It should be understood that no action or function described or claimed herein is performed by the human mind. No action or function described or claimed herein can be practically performed in the human mind. An interpretation that any action or function described or claimed herein can be performed in the human mind is inconsistent with and contrary to this disclosure.

### —Example Frequency-Domain Clustering System—

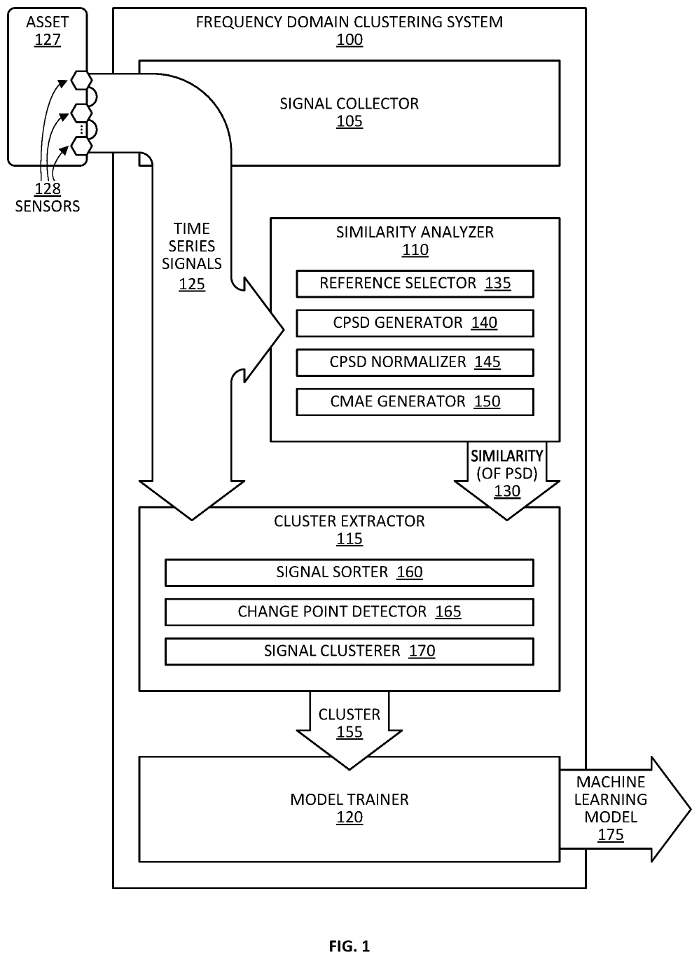

FIG. 1 illustrates one embodiment of a frequency-domain clustering system 100 associated with clustering of time series signals based on frequency domain analysis. Frequency-domain clustering system 100 includes components for gathering time series signals into clusters based on similarity of the signals in the frequency domain. In one embodiment, the components of frequency-domain clustering system 100 include a signal collector 105, a similarity analyzer 110, a cluster extractor 115, and a model trainer 120.

In one embodiment, signal collector 105 is configured to access, retrieve, or otherwise obtain time series signals 125. Time series signals 125 are to be separated into clusters. Time series signals 125 may be a collection of time series signals that share an index. Time series signals 125 are undifferentiated with respect to clusters among time series signals 125. In other words, time series signals 125 include clusters that are unidentified or unlabeled as being clusters. In one embodiment, the time series signals 125 include both a training range of indexes and a surveillance range of indexes. The training range and surveillance range may be discrete from each other, for example with the surveillance range being subsequent to the training range. In one embodiment, signal collector 105 is configured to access the training range of the time series signals 125. In one embodiment, time series signals 125 describe physical states of an asset 127. In one embodiment, time series signals 125 are produced by one or more sensors 128. In one embodiment, sensors 128 are configured to produce the time series signals 125 as descriptions of the physical states of the asset 127 over time.

In one embodiment, similarity analyzer 110 is configured to determine similarity 130 of power spectral density among the time series signals 125. More generally, similarity analyzer 110 is configured to determine similarity 130 in the frequency domain among the time series signals 125. For example, similarity analyzer 110 is configured to determine measures of correlation (which quantify similarity 130) among the time series signals 125 based on analysis in the frequency domain.

In one embodiment, similarity analyzer 110 includes components configured to perform a comparison (or other analysis of similarity) of the time series signals 125 in the frequency domain. Similarity analyzer 110 includes a reference selector 135, a CPSD generator 140, a CPSD normalizer 145, and a CMAE generator 150. In one embodiment, reference selector 135 is configured to select one of the time series signals 125 to be a reference signal. In one embodiment, CPSD generator 140 is configured to generate cross power spectral densities (CPSD) between the reference signal and the others of the time series signals 125. In one embodiment, CPSD normalizer 145 is configured to normalize the cross power spectral densities (produced by CPSD generator 140) to a periodogram of the reference signal (chosen by reference selector 135). In one embodiment, CMAE generator 150 is configured to generate a cumulative mean absolute error (CMAE) of the normalized cross power spectral densities with respect to the reference signal. In one embodiment, the similarities 130 (measures of correlation) of power spectral density for the time series signals are the cumulative mean absolute errors of the cross power spectral densities produced by CMAE generator. In this way, similarity analyzer 110 is configured to determine the extent to which time series signals are similar by performing a comparison of the time series signals in a frequency domain.

In one embodiment, cluster extractor 115 is configured to extract a cluster 155 of similar time series signals from the time series signals 125 based on the similarity 130 of power spectral density. More generally, cluster extractor 115 is configured to extract the cluster 155 of similar time series signals from the time series signals 125 based on the similarity 130 in the frequency domain. For example, cluster extractor 115 is configured to transfer time series signals into a cluster 155 based on the measures of correlation. The measures of correlation quantify similarity 130.

In one embodiment, cluster extractor 115 includes components for choosing signals that belong to a cluster based on similarity 130 of the signals in the frequency domain. In one embodiment, cluster extractor 115 includes signal sorter 160, change point detector 165, and signal clusterer 170. In one embodiment, signal sorter 160 is configured to sort the time series signals 125 based on the similarity 130 in the frequency domain (e.g., of power spectral density) of a time series signal with other time series signals. In one embodiment, change point detector 165 is configured to detect a change point in the similarities 130 for the time series signals 125. In one embodiment, the change point in the similarities 130 for the time series signals 125 is detected by applying a Mann-Kendall test to the mean cumulative function of the similarities 130 (i.e., the cumulative sum of the cumulative mean absolute errors that were used as measures of correlation) in the sorted order of the time series signals 125. In one embodiment, signal clusterer 170 is configured to choose individual ones of the time series signals 125 up to and including the change point to be in the cluster 155. In another embodiment, signal clusterer 170 is configured to choose individual ones of the time series signals 125 up to but not including the change point to be in the cluster 155. In this way, cluster extractor 115 is configured to create cluster 155 by choosing those of the time series signals 125 below a jump of dissimilarity (such as a discontinuity in the measures of correlation) to be included in the cluster 155 of time series signals.

In one embodiment, model trainer 120 is configured to train a machine learning model 175 to detect anomalies based on the cluster. In one embodiment, model trainer is configured to train machine learning model 175 to detect anomalies in a surveillance range of the cluster based on the training range of the cluster. In one embodiment, the machine learning model 175 is a multivariate state estimation technique model. In one embodiment, model trainer 120 is configured to assign the time series that are in the cluster 155 to be inputs of the machine learning model 175 (such as inputs of the multivariate state estimation technique model). And, model trainer 120 is configured to not assign the time series that are excluded from the cluster 155 to be inputs of the machine learning model 175.

In one embodiment, frequency-domain clustering system 100 includes additional components. In one embodiment, frequency-domain clustering system includes an anomaly detector and an alert generator. In one embodiment, the anomaly detector is configured to detect an anomaly in cluster 155 with the trained machine learning model 175. In one embodiment, the alert generator is configured to generate an electronic alert that the anomaly was detected in the cluster of the time series signals.

In one embodiment, frequency-domain clustering system 100 may be configured to extract a plurality of clusters from the time series signals. In one embodiment, frequency-domain clustering system 100 is configured to repeat determining similarity in the frequency domain using similarity analyzer 110 and extracting a cluster of similar time series signals using cluster extractor 115 until no further change point is detectable at a given confidence level. And, frequency-domain clustering system 100 may be configured to place the remaining time series signals that were not extracted into a final cluster once no further change point is detected.

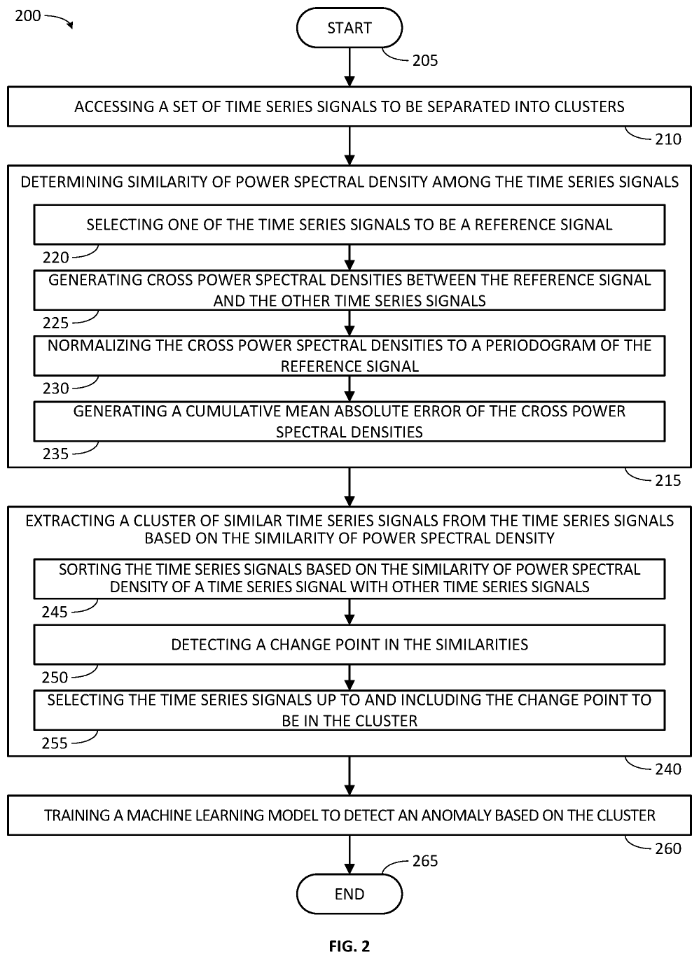

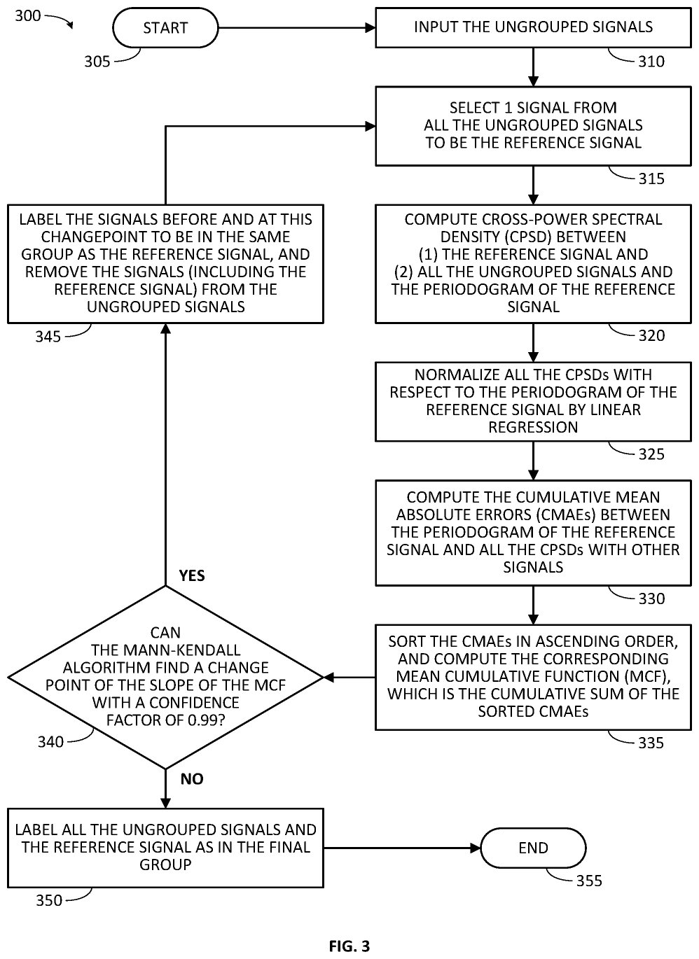

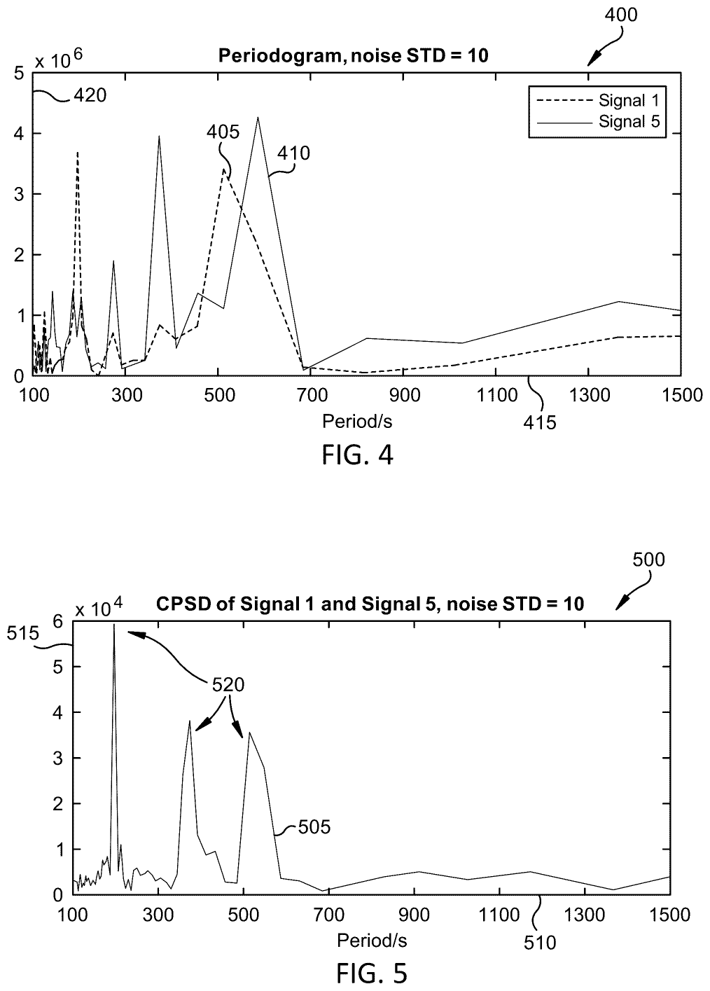

Further details regarding frequency-domain clustering system 100 are presented herein. In one embodiment, the operation of frequency-domain clustering system 100 will be described with reference to example frequency-domain clustering methods 200 and 300 shown in FIGS. 2 and 3. Additional details regarding the operation of frequency-domain clustering system 100 are presented in the context of visualizations of example data in FIGS. 4-13 during steps of frequency-domain clustering methods 200 and 300.

### —Example Frequency-Domain Clustering Method—

FIG. 2 illustrates one embodiment of a frequency-domain clustering method 200 associated with clustering of time series signals based on frequency domain analysis. Initially, a collection of time series signals that is to be separated into clusters are accessed. Similarities in the frequency domain (for example, similarity of power spectral density) are determined among the time series signals. These similarities are measures of correlation between pairs of signals (such as a cross-power spectral density between a reference signal for a cluster and another signal in the collection). A cluster of similar time series signals is then extracted or removed from the collection of time series signals. The cluster—that is, the signals that belong in the cluster—are identified based on the similarity in the frequency domain for the signals. A cluster-specific machine learning model is then trained based on the cluster to detect anomalies in the cluster. For example, a training range (of observations) of the cluster is used to train the model, and the trained model will monitor a surveillance range of the cluster. In one embodiment, the process may be repeated to extract multiple or all clusters from the collection of time series signals.

In one embodiment, frequency-domain clustering method 200 initiates at START block 205 in response to determining by a frequency-domain clustering system one or more of (i) that a frequency-domain clustering system has received or has begun receiving a set of time series signals; (ii) that an instruction to perform frequency-domain clustering method 200 on a set of time series signals/readings has been received (iii) a user or administrator of an frequency-domain clustering system has initiated frequency-domain clustering method 200; (iv) it is currently a time at which frequency-domain clustering method 200 is scheduled to be run; or (v) that frequency-domain clustering method 200 should commence in response to occurrence of some other condition. In one embodiment, a computer system configured by computer-executable instructions to execute functions of frequency-domain clustering system 100 executes frequency-domain clustering method 200. Following initiation at start block 205, frequency-domain clustering method 200 continues to process block 210.

### —Example Method—Accessing Time Series Signals—

At block 210, frequency-domain clustering method 200 accesses time series signals to be separated into clusters. For example, frequency-domain clustering method 200 may access a collection of time series signals that are undifferentiated with respect to clusters. Or, for example, frequency-domain clustering method may access a training range of time series signals that include unidentified clusters. More simply, the frequency-domain clustering method 200 gets a collection of time series signals so that the collection may be then searched for correlated signals to move out of the collection and into separate clusters. In short, in one embodiment the frequency domain clustering method 200 inputs ungrouped signals for subsequent grouping into clusters.

In one embodiment, the collection of time series signals are a time series database. The time series signals may be generated by or otherwise associated with sensors that are configured to transduce physical phenomena occurring in or around an asset into measurements. The measurements may be sampled to produce the time series signals. For example, the time series signals may include time series signals from various constituent devices of an aircraft, such as from separate engines, hydraulic systems, fuel pumps, and other aircraft systems. The sensors (or intermediate systems) transmit the time series signals to the frequency-domain clustering system 100.

Time series signals may be intermixed together in the collection of time series signals without regard to correlation of activity between the signals. The signals are thus undifferentiated and include unidentified groups of signals that exhibit shared or matching patterns of activity. The time series signals might not be labeled with respect to groups of correlated activity in the time series signal. For example, a collection of time series signals produced by an oil refinery may simply be numbered with signal numbers 1-1,000,000 (or similarly uninformative identifiers), without indication as to which signals are related to each other. In other words, clusters of correlated signals may be hidden in or dispersed throughout the collection of time series signals. Accordingly, the collection of time series signals is to be separated into its constituent clusters.

In one embodiment, only a training range (of observations or vectors) is accessed and used for identification of the clusters. For example, an initial number of observations or vectors are retrieved from the collection of time series signals. In one embodiment, the training range is long enough to accommodate multiple periods of cyclic correlated activity in the collection of time series signals.

In one embodiment, accessing the time series signals includes retrieving the time series signals from memory or storage. In one embodiment, the frequency-domain clustering method accepts a user input that indicates a collection of time series signals to be accessed. The frequency-domain clustering method 200 establishes a connection to a data source that includes the collection of time series signals. Then, the frequency-domain clustering method 200 composes and executes a query on the data source to retrieve the time series signals (such as a query to retrieve a training range of the time series signals). The query is configured to cause the data source to return the time series signals. Or, frequency-domain clustering method 200 composes and executes a query on the data source to cause the time series to be available for create, read, update, and/or delete operations.

Also, in one embodiment, accessing the time series signals may include receiving live, real-time signals from sensors monitoring an asset. In one embodiment, the frequency-domain clustering method 200 establishes a connection to a stream of observations of the time series signals. Individual observations arriving from the stream are placed into a buffer as they arrive to create batches of observations. The batches of observations may be processed according to the method steps described herein. Generally, the real time processing of time series signals is performed in a surveillance phase after the time series signals have already been separated into clusters.

Thus, in one embodiment, frequency-domain clustering method 200 accesses time series signals to be separated into clusters by accepting an input specifying a collection of time series signals and then generating and executing one or more commands (such as a query) to cause the collection of time series signals to be made available for create, read, update, and delete operations. The collection of time series signals may be placed into memory or storage for subsequent processing. At the conclusion of process block 210, a collection of time series signals that includes identified clusters is made ready for a frequency-domain clustering analysis. In one embodiment, the functions of process block 210 are performed by signal collector 105 of frequency-domain clustering system 100.

### —Example Method—Determining Similarity in Frequency Domain—

At block 215, frequency-domain clustering method 200 determines similarity of power spectral density among the time series signals. More generally, frequency-domain clustering method 200 determines similarity in a frequency domain among the time series signals. Or, frequency-domain clustering method 200 determines measures of correlation (also referred to herein as “similarities”) among the time series signals based on analysis in the frequency domain. In other words, the frequency-domain clustering method 200 finds out how much alike the signals are in the frequency domain. The extent to which the activity in the signals is alike, that is, correlated, may then be used to determine whether or not a signal belongs in a cluster along with a reference signal.

In one embodiment, determining similarity of time series signals in the frequency-domain includes steps to produce a measure of correlation or similarity with a reference signal for the signals that are in the collection. In one embodiment, the measure of correlation or similarity for a given signal is a cumulative mean absolute error (CMAE) of cross power spectral density (CPSD) between a reference signal and the given signal. In one embodiment, at block 220, one of the time series signals is selected to be a reference signal. Then, at block 225, cross power spectral densities are generated between the reference signal and the other time series signals. At block 230, the cross power spectral densities are normalized to a periodogram of the reference signal. At block 235 cumulative mean absolute errors of the cross power spectral densities are generated. The cumulative mean absolute errors of the cross power spectral densities is then used as measures of correlation or similarity in the frequency domain (similarity of power spectral density).

In one embodiment, a reference signal is an arbitrarily selected one of the time series signals that remains (that is, has not yet been added to a cluster) in the collection of signals. The reference signal is a signal used as a benchmark signal or baseline signal from which the frequency-domain clustering method 200 can measure similarity of other signals. In other words, the similarity of signals in the collection are measured from the reference signal so as to provide a consistent measure of correlation. Frequency-domain clustering method 200 will use the reference signal as a basis of a new cluster, as discussed below at block 240. At block 220, frequency-domain clustering method 200 chooses one of the available signals to be the reference signal. For example, the reference signal may be selected at random from those signals in the collection that have not yet been placed in clusters. Or, for example, the reference signal may be the next available signal (for example, the lowest in terms of signal index) in the collection of signals that is not already allocated to a cluster.

The CPSD between two signals is a measure of how the power of one signal relates to the power of another signal across a spectrum of frequencies. Peaks in the CPSD of two signals show the periods (or frequencies) at which the activity of the two signals is correlated. At block 225, frequency-domain clustering method 200 generates cross power spectral densities between the reference signal and the other time series signals. To generate the CPSDs, frequency-domain clustering method 200 applies an FFT to the reference signal and the other time series signals in the collection of time series signals to convert the signals from the time domain into the frequency domain. The power spectral density function resulting from the FFT of the reference signal may also be referred to herein as a periodogram of the reference signal.

Then, the frequency-domain clustering method 200 performs cross power calculations on pairs of the FFT-converted signals. The cross-power calculation multiplies the complex conjugate of the FFT of one signal in the pair by the FFT of the other signal in the pair to produce the CPSD function for the pair of signals. These pairwise cross-power calculations are for pairs of the reference signal with the other signals in the collection. Thus, for the N signals that remain in the collection, where the reference signal is signal 1, the cross-power calculation is performed on the following pairs of signals that have been converted into the frequency domain: (reference signal, signal 2), (reference signal, signal 3), . . . , (reference signal, signal N). Thus, in one embodiment, a CPSD function is thereby produced for each signal in the collection that shows how the signal relates to the reference signal. The CPSD of the reference signal and a given signal may be referred to as the CPSD for the given signal.

Generally, CPSDs for signals other than the reference signal will have a magnitude that differs from the magnitude of the periodogram of the reference signal. Thus, at block 230, frequency-domain clustering method 200 normalizes the CPSDs to the periodogram of the reference signal. The normalization adjusts the CPSD for a signal to match the magnitude of the periodogram of the reference signal. In this way, the bivariate CPSD density functions for the other signals are scaled with respect to the univariate FFT density function of the reference signal. The normalization of CPSDs is performed to ensure that the CPSDs of signals that are similar to the reference signal consistently have small residuals with the periodogram of the reference signal, and that the CPSDs of signals that are not similar to the reference signal consistently have large residuals with the periodogram of the reference signals. This manner of normalization causes the signals that are dissimilar to the reference signal to be poorly normalized, and this will exaggerate the residuals of the dissimilar signal and further boost a Cumulative Mean Absolute Error for the dissimilar signal at block 235.

In one embodiment, the frequency-domain clustering method 200 performs normalization of the CPSDs to the periodogram of the reference signal using a linear regression procedure. For example, for each frequency increment (or point within a frequency spectrum), frequency-domain clustering method 200 determines the logarithm of the periodogram of the reference signal at the frequency increment, and determines the logarithm of the CPSD at the frequency increment. Then, frequency-domain clustering method 200 performs a linear regression between the logarithm values for the periodogram of the reference signal and the CPSD to find a scaling factor that minimizes the difference between the logarithms for the periodogram of the reference signal and the logarithms for the CPSD. Then, multiply the CPSD by the scaling factor to normalize the CPSD to the periodogram of the reference signal. In one embodiment, this normalization is performed for the CPSDs of each of the signals remaining in the collection other than the reference signal.

The frequency-domain clustering method 200 then finds a cumulative mean absolute error (CMAE) for the CPSDs with reference to the periodogram of the reference signal. At block 225, frequency-domain clustering method 200 generates cumulative mean absolute errors of the normalized cross power spectral densities with respect to the periodogram of the reference signal. In one embodiment, at each frequency increment, the frequency-domain clustering method 200 finds the residuals (or absolute errors) between the normalized CPSD and periodogram of the reference signal. The residual or absolute error between a normalized CPSD and periodogram of the reference signal at a frequency increment is the absolute value of the difference between the normalized CPSD and periodogram at the frequency increment. The frequency-domain clustering method 200 then finds the cumulative sum of the residuals over all the frequency increments to produce the CMAE for a signal. The CMAE for a signal may then be used as the similarity or measure of correlation for the signal. In this way, the measures of correlation or similarity among the time series signals are based on cumulative mean absolute errors of cross power spectral density between one of the time series signals that is selected as a reference and others of the time series signals.

Thus, in one embodiment, frequency-domain clustering method 200 determines similarity among the time series signals in a frequency domain by (i) choosing a reference signal, (ii) converting the signals in the collection into periodograms in the frequency domain, (iii) generating CPSDs with the reference signal for each of the other signals, (iv) normalizing the CPSD for the other signals to the periodogram of the reference signal, (v) determining the residuals between the periodogram of the reference signal and the normalized CPSD for each of the other signals, and (vi) for each of the other signals, combining the residuals to produce a CMAE value that serves as a measure of correlation or similarity with the reference signal for the signal. At the conclusion of process block 215, a measure of similarity or correlation in the frequency domain with a reference signal has been generated for the signals that remain in the collection. The measure of similarity with the reference signal for a signal can be used to determine whether the signal can then be used (as discussed below) to determine whether the signal should be placed into a cluster with the reference signal (as discussed below). In one embodiment, the functions of process block 215 are performed by similarity analyzer 110 of frequency-domain clustering system 100. In particular, in one embodiment, the functions of block 220 are performed by reference selector 135, the functions of block 225 are performed by CPSD generator 140, the functions of block 230 are performed by CPSD normalizer 145, and the functions of process block 235 are performed by CMAE generator 150.

### —Example Method—Extracting a Cluster of Time Series Signals—

At block 240, frequency-domain clustering method 200 extracts a cluster of similar time series signals from the time series signals based on the similarity of power spectral density. Or, more generally, frequency-domain clustering method 200 chooses a cluster of similar time series signals from the time series signals based on the similarity in the frequency domain. For example, frequency-domain clustering method 200 transfers time series signals into a cluster based on the measures of correlation or similarity between the signals and the reference signal. In one embodiment, frequency-domain clustering method 200 collects the signals that are most like the reference signal in the frequency domain and moves them into a cluster with the reference signal. In this way, frequency-domain clustering method 200 filters out the signals that are not enough like the reference signal to be included in a cluster with the reference signal.

In one embodiment, frequency-domain clustering method 200 includes the reference signal in the new cluster. Frequency-domain clustering method 200 determines whether to include other signals from the collection of signals in the new cluster along with the reference signal. Frequency-domain clustering method 200 makes the determination as to whether to include other signals based on the similarity of the signals to the reference signal in the frequency domain. In particular, Frequency-domain clustering method 200 makes the determination as to whether to include a signal based on the CMAE.

In one embodiment, this process of extracting a cluster of similar time series signals from the time series signals based on the similarity in the frequency domain (e.g., similarity of power spectral density) includes steps for choosing those of the time series signals below a jump of dissimilarity to be the cluster of time series signals. In one embodiment, at block 245, the time series signals are sorted based on the similarity of power spectral density of a time series signal with other time series signals. At block 250, a change point is detected in the similarities for the time series signals. At block 255, the time series signals below the change point (e.g., up to and including the change point, up to but not including the change point) are selected to be in the cluster.

In one embodiment, the signals in the collection are sorted based on the measure of correlation or similarity (in the frequency domain) for each signal with the reference signal. At block 245, frequency-domain clustering method 200 sorts the time series signals based on the similarity of power spectral density of a time series signal with other time series signals. For example, the signals are placed into an ascending order of CMAE. In this order, each subsequent signal is equally or less similar to the reference signal than the preceding signal. Thus, the signals will start with the reference signal, which will have a CMAE of 0 because it is completely similar to itself. Then, the signals will grow progressively more different from the reference signal. The sorting may be performed using any of a variety of sorting algorithms, such as quicksort, merge sort, heap sort, block sort, bucket sort, and so on, or combinations thereof.

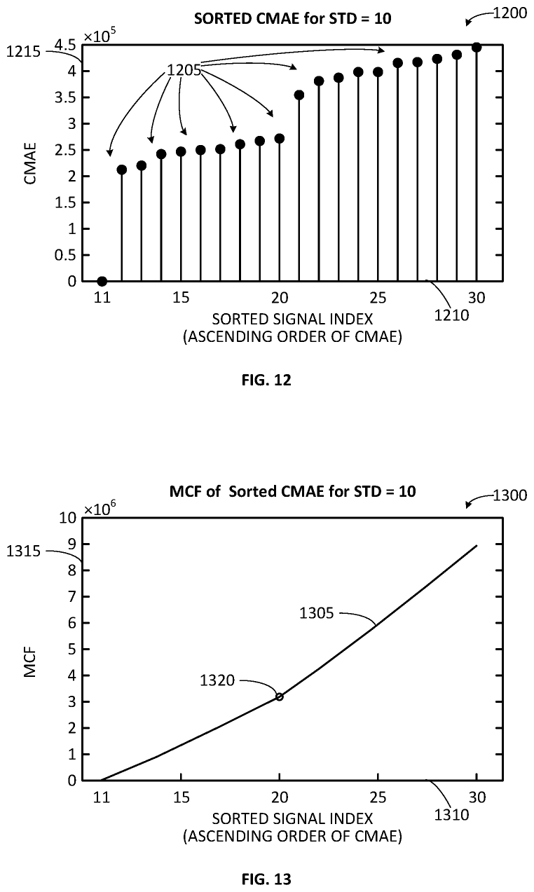

In one embodiment, where more than one cluster exists in the collection of signals, there will exist a change point in the CMAE measure of correlation or similarity between the signals that belong in a cluster with the reference signal, and the signals that do not belong in the cluster with the reference signal. Therefore, at block 250, frequency-domain clustering method 200 detects a change point in the similarities (CMAEs) for the time series signals. The change point indicates a jump of dissimilarity or discontinuity in the CMAEs of signals beyond the change point. (The jump is visible, for example, in FIG. 9 between signals 10 and 11 and FIG. 12 between signals 20 and 21.) The reference signal is the lower boundary (inclusive) of the cluster of signals within the sorted collection of signals. The change point is the upper boundary (inclusive) of the cluster of signals within the sorted collection of signals. Signals beyond the change point in the sorted collection (that is, signals with CPSDs higher than the CPSD of the signal at the change point) are excluded from the cluster of signals.

In one embodiment, to detect the change point, the frequency-domain clustering method 200 (i) determines a mean cumulative function (MCF) of the CMAEs, and (ii) applies a Mann-Kendall test (or other change point detection test) to the MCF to identify at which signal the change point occurs. The MCF is defined as the cumulative summation of the CMAEs in the sorted order. The frequency-domain clustering method 200 generates the MCF from the sorted CMAEs. For example, the frequency domain clustering method 200 generates the value of the MCF at a signal by determining and summing the CMAEs for preceding signals up to and including the signal. In one embodiment, the resulting MCF will have a very straight nondecreasing slope for all (sorted) CMAEs for signals that belong in a cluster with the reference signal, but will exhibit a change in slope for signals not in the cluster.

In one embodiment, the frequency-domain clustering method 200 uses the Mann-Kendall (MK) test to detect the change point based on the MCF. The MK test detects when a trend away from the initial slope of the MCF occurs, based on an analysis of data points in the MCF. The data points in the MCF are the values of the MCF for the signals in sorted order. In one embodiment, the MK test is used on progressively more of the MCF until a trend is detected with sufficient confidence. For example, the MK test is performed on the MCF values for the first 2 signals in sorted order (number of data points n=2), then on the MCF values for the first 3 signals in sorted order (n=3), then on the MCF values for the first 4 signals in sorted order (n=4), and so on, until the confidence factor for the existence of a trend satisfies a threshold condition. In one embodiment, the data point at which the trend is detected with a confidence factor that satisfies the threshold condition is selected as the change point. Additional detail on the Mann-Kendall test and associated confidence factors is described elsewhere herein, for example under the heading “Mann-Kendall Analysis”.

In one embodiment, the threshold condition is pre-specified, for example by user input or configuration of the frequency-domain clustering system. In one embodiment, the confidence factor indicates the probability p of incorrectly finding a trend (which indicates a change point) where there is none at a given data point n. This may be referred to as a false-alarm probability. In this case, the threshold condition may be set to stipulate that the chance of finding a change point where there is none should be 5% or less (p≤0.05). For increased confidence in the detection of change points, the threshold may be set even more restrictively, for example, stipulating that the chance of finding a change point where there is none should be 1% or less (p≤0.01). The converse (1−p) of the probability of finding a change point where there is none is the probability that a detected trend (change point) at a given data point n is truly a change point. The threshold condition may also be set based on this (1−p) confidence that there actually is change point at the given data point n, for example by requiring that the probability that the detected change point is actual should be 95% or more (1−p≥0.95), or 99% or more (1−p≥0.99). In one embodiment, threshold conditions specifying a false alarm probability (chance of finding a change point where there is none) of 10% or less (p≤0.1) may be satisfactory for change point detection.

Once the change point has been detected based on the MCF, at block 255, frequency-domain clustering method 200 selects the time series signals below the change point to be in the cluster. In one embodiment, the time series signals below the change point that are selected are the time series signals up to but not including the change point. In another embodiment, the time series signal at the change point may be included in the cluster, and the signals below the change point that are selected are the time series signals up to and including the change point. Which of these cases is used is determined based on which of two signals on either side a change in MCF slope is designated to be the change point. Where the last signal before the change in MCF slope is designated to be the change point, then the signals up to and including the change point are included in the cluster. And, where the first signal following the change in MCF slope is designated to be the change point, then the signals up to but not including the change point are included in the cluster. In either case, signals beyond the discontinuity in CMAE values that is indicated by the change point in the MCF are excluded from the cluster, and signals preceding the discontinuity are added to the cluster.

In one embodiment, the selected signals are transferred into a newly defined cluster. In one embodiment, the signals that are added to the cluster are removed from the collection of signals so that the signals in the cluster will not be considered for inclusion in other clusters in subsequent iterations of the clustering process. In one embodiment, the time series signals that have been added to the cluster are removed from the collection of time series signals by setting a flag or label associated with the signals in the cluster that indicates that the signals are in a cluster. In one embodiment, the time series signals that were added to the cluster are removed from the collection by restructuring or redefining the collection of signals to exclude the signals in the cluster, and include the remaining signals that were not added to the cluster. For example, where the collection of time series signals is a time series database, the collection may be split into two time series databases, one for the cluster, and one for the remaining signals. Thus, the signals that are included in the cluster are gathered together separately from the remaining signals of the collection. The remaining signals that were not included in the cluster with the reference signal may be analyzed for the presence of further clusters.

Thus, in one embodiment, frequency-domain clustering method 200 extracts a cluster of similar time series signals based on the similarity in the frequency domain by (1) sorting the time series signals by ascending order of CMAEs associated with the signals, (2) generating an MCF of the CMAEs, (3) detecting a change point in the CMAEs by analyzing progressively larger ranges of the MCF with a Mann-Kendall test until a threshold condition for confidence is satisfied, indicating the that the signal index for the top of the range is the change point, and (4) transferring the time series signals up to and including the change point into the cluster. At the conclusion of process block 240, one cluster of similar or correlated signals has been extracted from the collection of signals. The cluster of signals may be used for training ML models that are specific to the cluster, and that are therefore specific to the components of the monitored asset that are exhibiting the correlated behavior of the clustered signals. In one embodiment, the functions of process block 240 are performed by cluster extractor 115 of frequency-domain clustering system 100. In particular, in one embodiment, the functions of block 245 are performed by signal sorter 160, the functions of block 250 are performed by change point detector 165, and the functions of process block 255 are performed by signal clusterer 170.

### —Example Method—Use of Cluster—

At block 260, frequency-domain clustering method 200 trains a machine learning model to detect anomalies based on the cluster. More particularly, frequency-domain clustering method 200 trains a machine learning model to detect anomalies based on the training range of the cluster. Then, in response to detecting an anomaly in a surveillance range of the cluster, frequency-domain clustering method 200 transmits an electronic alert that the anomaly has occurred in the cluster. Because a plurality of clusters in the collection of time series signals is presented to discrete machine learning models (or other analyses) that are specific to the individual clusters of the plurality, frequency-domain clustering method 200 routes the cluster to a destination that is discrete from destinations for other clusters detected in the time series signals. Put simply, the frequency-domain clustering method 200 associates the cluster with a dedicated machine learning model that is configured specifically for the cluster. In one embodiment, signals outside of the cluster are excluded from training of and surveillance with the machine learning model.

In one embodiment, a machine learning model is assigned to the time series signals in a cluster as multivariate inputs of the machine learning model. The machine learning model parses a training range of the time series signals of the cluster in an automatic training operation. The automatic training operation adjusts a configuration to cause the ML model to produce estimates consistent with the time series signals in the cluster. The training causes the machine learning model to be configured to produce estimates of what each signal in the cluster is expected to be based on the actual values of other signals in the cluster. The trained ML model is then stored for subsequent use to monitor a surveillance range of the signals in the cluster. For example, the configuration of the trained ML model may be written to a data structure that may be used to configure instances of the trained ML model. Differences or residuals between the estimates may be provided to a detection model such as the sequential probability ratio test (SPRT) to detect when deviations from expected signal values are anomalous. The trained ML model is then stored for subsequent use to monitor ensemble averaged signals, such as the other averaged signal for anomalies. In this way, a trained machine learning model that is dedicated to the cluster may be automatically generated. Additional detail on training of the machine learning model to detect an anomaly is provided below under the heading “Overview of Multivariate ML Anomaly Detection”.

Thus, the machine learning model is trained to detect incorrect, improper, or otherwise anomalous operation of the asset based on the cluster. The training range of the cluster provides an initial reference state of the asset and/or physical phenomena associated with the asset. In one embodiment, the training range of the cluster is designated to represent a nominal, expected, or otherwise normal operational state of the asset. The anomalous operation may indicate that the asset is entering or has entered a degraded state of operation that differs from the initial reference state. In other words, the anomalies represent physical degradation or incipient failure of the asset. Note that the cluster may represent a particular component or area of the asset that is associated with the correlated behavior of the signals in the cluster, in which case the anomalies represent physical degradation or incipient failure in the particular component or area of the asset.

In one embodiment, once the machine learning model is trained, the machine learning model may be used to monitor the cluster of signals for anomalous deviations from expected values. Thus, in one embodiment, following the training of the machine learning model, frequency-domain clustering method 200 monitors the cluster and, in response to detecting an anomaly, generates an electronic alert. In one embodiment, during a surveillance phase in which frequency-domain clustering method 200 monitors a surveillance range of the cluster for anomalies, frequency-domain clustering method 200 detects an anomaly with the trained machine learning model. In response to the detection of the anomaly, frequency-domain clustering method 200 generates an electronic alert that the anomaly was detected in the cluster of the time series signals. The electronic alert may indicate that the asset, or more particularly a specific component of the asset that is associated with the cluster, is undergoing degradation or incipient failure. Additional detail regarding signal surveillance by the machine learning model is described elsewhere herein, for example under the heading “Overview of Multivariate ML Anomaly Detection”.

The trained ML model is specific to one cluster. The ML model was trained only on signals of the cluster. Other time series signals are filtered out when creating the cluster prior to training the ML model. In one embodiment, this causes the ML model trained on the cluster generated as described herein to exhibit improved prognostic accuracy. In one embodiment, the ML model trained on the cluster that is created as described herein generates fewer false alarm probabilities (FAPs) and fewer missed alarm probabilities (MAPs) than an ML model trained with the entire collection of time series signals. Also, in one embodiment, a plurality of ML models trained on an associated plurality clusters that are extracted from the collection of time series signals as described herein exhibits similarly improved prognostic accuracy than an ML model trained with the entire collection of time series signals. Further, a plurality of ML models trained on an associated plurality clusters that are extracted from the collection of time series signals as described herein requires fewer compute operations for training and monitoring than does an ML model trained with and monitoring the entire collection of time series signals. This is because the compute load of a multivariate ML model increases with square of the number of input signals. Thus, in one embodiment, the frequency-domain clustering techniques described herein both (1) increase ML accuracy and (2) substantially decrease the compute load of ML training and surveillance. These are clear improvements to the technology of ML prognostic surveillance of assets.

At the conclusion of block 260, a trained machine learning model that is specifically dedicated to the cluster has been configured. In one embodiment, trained machine learning models specifically dedicated to other clusters in the collection of signals may also be produced. In one embodiment, the ML models are provided with multivariate inputs that are correlated in activity, regardless of a high level of measurement noise. Thus, in one embodiment, the resulting ML anomaly detection models are highly accurate due to exclusion of signals not relevant to modeling of the correlated activity (and underlying component of the asset) for which the ML model was created.

In one embodiment, frequency-domain clustering method 200 repeats the functions of blocks 215-260 to extract a plurality of clusters from the collection of time series signals, and train a plurality of ML models associated with the clusters. For example, the steps of determining similarity in the frequency domain (e.g., similarity of power spectral density) and extracting a cluster of similar time series signals are repeated until no further change point is detected at a given confidence level. In one embodiment, frequency-domain clustering method 200 places the remaining time series signals that were not extracted into a final cluster once no further change point is detected. Additional ML models are then configured to accept the signals of the additional clusters as their multivariate inputs, and trained to produce estimates consistent with the clusters. Additional detail regarding this repeated loop are described below for example with reference to FIG. 3.

### —Further Embodiments of Example Frequency-Domain Clustering Method—

In one embodiment, determining similarity of power spectral density among the time series signals (as discussed above at block 215) further includes performing a comparison of the time series signals in a frequency domain. In one embodiment, determining similarity of power spectral density among the time series signals includes steps for making the comparison, as follows. Frequency-domain clustering method 200 selects one of the time series signals to be a reference signal. Frequency-domain clustering method 200 then generates cross power spectral densities between the reference signal and the other time series signals. Frequency-domain clustering method 200 next normalizes the cross power spectral densities to a periodogram of the reference signal. From these normalized CPSDs, frequency-domain clustering method 200 generates a cumulative mean absolute error of the cross power spectral density. The similarity of power spectral density is the resulting cumulative mean absolute errors of the cross power spectral density. In other words, the measures of correlation (similarity) among the time series signals are based on cumulative mean absolute errors of cross power spectral density between the time series signals and one of the time series signals that is selected as a reference.

In one embodiment, extracting a cluster of similar time series signals from the time series signals based on the similarity of power spectral density (as discussed above at block 240) further includes choosing those of the time series signals below a jump of dissimilarity to be the cluster of time series signals. In one embodiment, extracting a cluster of similar time series signals from the time series signals based on the similarity of power spectral density includes steps for detecting the jump of dissimilarity, as follows. Frequency-domain clustering method 200 sorts the time series signals based on the similarity of power spectral density of a time series signal with other time series signals. Frequency-domain clustering method 200 then detecting a change point in the similarities for the time series signals. In one embodiment, the change point in the similarities for the time series signals is detected by applying a Mann-Kendall test to the mean cumulative function of the similarities in the sorted order of the time series signals. Frequency-domain clustering method 200 then selects the time series signals up to and including the change point to be in the cluster.

In one embodiment, to facilitate identification of the signals to extract into the cluster, the signals are sorted in ascending order. Thus, in one embodiment of frequency-domain clustering method 200, transferring time series signals into a cluster based on the measures of correlation (as discussed above at block 240) further includes sorting the time series signals in ascending order of the measures of correlation (similarity). Then, frequency-domain clustering method 200 transfers into the cluster those of the time series signals having a measure of correlation below a discontinuity in the measures of correlation for the sorted time series signals.

Thus, in one embodiment, when extracting a cluster of similar time series signals from the time series signals based on the similarity of power spectral density, frequency-domain clustering method 200 applies a Mann-Kendall test to detect a change point in the time series signals. The time series signals are in sorted in order of similarity to facilitate detection of the change point. And, frequency-domain clustering method 200 then chooses those of the time series signals below the change point to be the cluster of time series signals.

In one embodiment, a plurality of clusters are extracted from the time series signals. In one embodiment, frequency-domain clustering method 200 repeats the steps of (1) determining similarity in the frequency domain (e.g., similarity of power spectral density) and (2) extracting a cluster of similar time series signals until no further change point is detected at a given confidence level. Frequency-domain clustering method 200 then places the remaining time series signals that were not extracted into a final cluster once no further change point is detected.

In one embodiment, the machine learning model (discussed above at process block 260) is a multivariate anomaly detection model (such as a multivariate state estimation technique (MSET) model). Thus, frequency-domain clustering method 200 further assigning the time series that are in the cluster to be inputs of the multivariate state estimation technique model. And, frequency-domain clustering method 200 does not assign the time series that are excluded from the cluster to be inputs of the multivariate state estimation technique model. The model is thus trained on and associated with a particular cluster of time series signals.

The foregoing training of a dedicated ML model for a particular cluster of signals is one example of how the clusters are routed to destinations that are discrete from the destinations of other clusters. In one embodiment, routing the cluster to a destination that is discrete from destinations for other clusters includes ML model training, monitoring, and alerting that are cluster-specific, as follows. In one embodiment, frequency-domain clustering method 200 trains a machine learning model to detect anomalies in the cluster, wherein the machine learning model is specific to the cluster. Then, frequency-domain clustering method 200 monitors a surveillance phase of the cluster with the trained machine learning model to detect an anomaly. In response to detecting the anomaly, frequency-domain clustering method 200 generates an electronic alert that the anomaly has occurred in the cluster.

In one embodiment, frequency-domain clustering system 100 further includes an asset that is configured to be monitored by one or more sensors, and the one or more sensors. The one or more sensors are configured to produce the time series signals as descriptions of physical states of the asset over time. Thus, in one embodiment, frequency-domain clustering method 200 identifies one or more clusters based on a training range of the time series signals, and then monitors the one or more clusters over a surveillance range of the time series signals. In one embodiment, the training range of the cluster describes a first physical state of the asset. In one embodiment, wherein the surveillance range of the cluster describes a second physical state of the asset. And, in one embodiment, the anomaly in the surveillance range of the cluster indicates that a degradation of the asset is occurring.

Thus, in one embodiment, one or more of the clusters are used to perform anomaly detection during a surveillance phase. In one embodiment, frequency-domain clustering method 200 detects an anomaly with the trained machine learning model. In response to the detection, frequency-domain clustering method 200 generates an electronic alert that the anomaly was detected in the cluster of the time series signals.

Advantageously, in one embodiment, frequency-domain clustering method 200 successfully distinguishes clusters of signals where noise levels are high enough to prevent cluster discrimination using time series techniques. For example, in one embodiment, frequency-domain clustering method 200 distinguishes clusters of signals where noise on one or more of the time series signals is in excess of 50%. Or, in one embodiment, frequency-domain clustering method 200 distinguishes clusters of signals where noise on one or more of the time series signals has a standard deviation in excess of 5.

### Discussion and Additional Embodiments

In one embodiment, the frequency-domain clustering systems and methods described herein demonstrate a radically new approach to signal clustering that operates in the frequency domain. That is, the frequency-domain clustering systems and methods described herein are based on analysis in the frequency domain for correlation between signals (rather than analysis in the time domain). The frequency-domain clustering systems and methods are robust against signal noise. In experimental validation, one example embodiment of a frequency-domain clustering system correctly clustered signals even when the noise ratios are at a factor of 10. This is confirmed using ground-truth knowledge of what clusters the signals belong to. This is unprecedented robustness for clustering signals correctly even when noise ratios are enormous.

The number of sensors in assets continues to grow exponentially. The growth in quantity of sensors for monitoring places further demands for improved clustering algorithms. When using ML algorithms to monitor the sensor signals, it is beneficial to employ effective clustering algorithms upstream from the core ML anomaly detection algorithm. It is computationally more efficient to break the database of signals into multiple (N) clusters and monitor those multiple clusters in parallel with individual ML models, versus trying to monitor the entire database of signals with one ML model. This is so because the compute cost for ML analysis goes up with the square of the number of signals. Hence, where the signals can be intelligently clustered into related groups that have good intra-signal correlations within each cluster, the overall compute cost is reduced significantly. Moreover, monitoring clusters of correlated signals using separate ML models that are dedicated to their respective cluster produces more accurate and earlier detection of anomalies.

Time-domain signal clustering algorithms may be satisfactory for identifying clusters when measurement noise on the signals is modest, for example 5% or less. However, time-domain signal clustering algorithms rapidly become inaccurate with any more than moderate noise on the signals. For example, time domain signal clustering algorithms readily mis-cluster the signals where the noise on the sensor signals rises to 10-20%. Further, where sensors produce inherent noise levels of 50% or more (i.e., noise ratios of 1.5 and above), time-domain signal clustering becomes completely ineffective.

In one embodiment, a reference signal is selected (as discussed above at process block 220) with which to evaluate the similarity with other signals through a bivariate frequency-domain cross-power spectral density (CPSD) analysis as applied to the other signals. In one embodiment, when a reference signal is picked, linear regression is applied to to normalize the CPSDs with respect to the reference signal's univariate periodogram. In other words, in one embodiment, the frequency-domain clustering technique uses linear regression to normalize pairwise CPSDs using a univariate periodogram for each reference signal. This manner of normalization ensures (i) that signals in the universe of signals that are actually similar to the reference signal will have small residuals, and (ii) that non-similar signals will be poorly normalized, causing residuals for the non-similar signals to be exaggerated and further boost the Cumulative Mean Absolute Errors (CMAEs) used to distinguish clusters in subsequent analysis. The CMAEs are measures of correlation between the reference signal and other signals. The CMAEs thus describe similarity of signals to the reference signal.

In one embodiment, after residuals and then CMAEs are determined, the CMAE measurements of similarity are analyzed to detect the clusters. In one embodiment, the analysis to detect the clusters employs determination of a Mean Cumulative Function (MCF) of the CMAEs that have been sorted in ascending order. The MCF has a very straight nondecreasing slope over the (sorted) CMAEs for signals in the same cluster. But, the MCF exhibits a change in slope for the (sorted) CMAEs of signals that are not in the cluster. The change in slope shows a jump or discontinuity in the CMAEs that represent the similarity of signals with the reference signal. A Mann-Kendall test is then employed for changepoint detection to identify the cluster boundary for the group of signals that are similar to the reference signal. The cluster boundary establishes where the signals belonging to the cluster separates from the other signals. The MCF curves are extremely linear and noise-free, even when the original raw data signals are contaminated with very large noise ratios. This is demonstrated in extensive reduction-to-practice experiments summarized below.

In one embodiment, the frequency-domain clustering systems and methods described herein increases the accuracy of ML surveillance of the clustered signals. In particular, ML surveillance of signals clustered using the In one embodiment, the frequency-domain clustering systems and methods described herein have lower false-alarm rates and lower missed alarm rates for ML prognostic anomaly discovery. In one embodiment, the frequency-domain clustering systems and methods described herein do not require hardware upgrades anywhere in the data center or monitored assets in order to obtain the improved accuracy, improved ability to monitor noisy signals, and reduced compute cost for monitoring. The frequency-domain clustering systems and methods described herein are thus immediately backward-compatible with existing data centers and sensor systems.

### —Additional Example Frequency-Domain Clustering Method—

FIG. 3 illustrates one embodiment of a frequency-domain clustering method 300 associated with clustering of time series signals based on frequency domain analysis. Frequency-domain clustering method 300 begins at START block 305, for example in response to occurrence of a condition similar to those described above for method 200. At block 310, the frequency-domain clustering method 300 inputs ungrouped signals. In one embodiment, the ungrouped signals are a collection of time series signals, such as a time series database that are not gathered into clusters. Given the collection of ungrouped signals, the following steps (a loop of blocks 315-345) are iteratively repeated to group the signals into clusters.

At block 315, the frequency-domain clustering method 300 selects 1 signal from all the ungrouped signals as the reference signal. In one embodiment, the lowest-numbered signal that remains in the collection is selected, in other words, the first signal in the ungrouped signals is picked to be the reference signal. In another embodiment, the reference signal is selected randomly from the signals that remain in the collection.

At block 320, the frequency-domain clustering method 300 determines or computes cross-power spectral density (CPSD) between the reference signal that was selected and all the other ungrouped signals. And, the frequency-domain clustering method 300 computes the periodogram of the reference signal. The periodogram of the reference signal is the CPSD of the reference signal with itself. In this way, measures of correlation or similarity with an arbitrarily selected reference signal are found for all signals in the collection of signals.

At block 325, the frequency-domain clustering method 300 normalizes the CPSDs of the signals with respect to the reference signal's periodogram. In one embodiment, the normalization is performed using linear regression. For example, the frequency-domain clustering method 300 normalizes the CPSD with a scaling factor and a shift factor to make it have a smallest-possible mean squared error (MSE) with respect to the reference signal's periodogram. The normalization step is employed to reconcile the magnitudes of different signals. Without the normalization, measured signals with different units, such as temperatures, voltages, rotations per minute (RPMs), etc., may have have large mean absolute errors simply because the original signals have different magnitudes.

At block 330, the frequency-domain clustering method 300 determines or computes the Cumulative Mean Absolute Errors (CMAEs) between the periodogram of the reference signal and all the normalized CPSDs produced by blocks 320 and 325.

At block 335, the frequency-domain clustering method 300 sorts the CMAEs in ascending order. And, the frequency-domain clustering method 300 then computes a mean cumulative function (MCF) of the sorted CMAEs. As mentioned above, the MCF is the cumulative summation of the CMAEs in the sorted order.

At block 340, the frequency-domain clustering method 300 checks for a change point of the slope of the MCF. In one embodiment, the check is performed using a Mann-Kendall (MK) algorithm. In one embodiment, the check for a change point is done with a Mann-Kendall algorithm to achieve sensitive and accurate change point detection. Alternatively, other tests may be used for change point detection, including other trend detection algorithms such as linear regression and Spearman's rho, as well as change point detection tests such as Pettitt's test, the von Neumann ratio test, cumulative sum tests, Bayesian change point analysis, and the standard normal homogeneity test. Detection of the change point is specified to satisfy a pre-provided threshold confidence factor. The confidence factor may specify a high level of confidence, for example, above 0.95, such as 0.99. The change point detected to the high level of confidence is clearly a change point. Change points detected at lower levels of confidence may not be as clearly a change point, and may cause clusters to be unnecessarily subdivided.

Block 340 is a base condition for the iterative steps for grouping the signals into clusters. Where a change point can be detected in the slope of the MCF with sufficient confidence (e.g., with confidence factor of at least 0.99), then there is at least one more cluster remaining in the collection of signals, and the frequency-domain clustering method 300 proceeds to block 345 and a further iteration through the loop. Where no change point can be detected in the slope of the MCF with sufficient confidence (e.g., with confidence factor of less than 0.99) then there are no further clusters to be extracted from the collection of signals, and the frequency-domain clustering method 300 proceeds to block 350, and termination of the loop.

At block 345, the frequency-domain clustering method 300 labels the signals before and at the detected change point to be in the same cluster as the reference signal. The frequency-domain clustering method 300 then extracts or removes the signals including the reference signal up through the signal at the change point from the remaining ungrouped signals, and places them into a cluster. For example, the signals are placed into the cluster by labeling the signals as belonging to the cluster. The signals in this cluster may be provided as inputs to a multivariate ML analysis specific to the cluster.

The frequency-domain clustering method 300 iteratively repeats the steps described above for blocks 315-345 until there is no change point detected (at block 340) with a confidence factor of 0.99. After that, at block 350, the signals that are still ungrouped when no further change point can be found define (that is, are placed into) one last cluster. Where the signals in the final cluster exhibit little cross correlation with the reference signal (as indicated by CMAE values that exceed a threshold), they may be used individually for univariate analyses. Where the signals in the final cluster exhibit substantial cross correlation with the reference signal (as indicated by CMAE value within a threshold), the signals may be provided as inputs to a multivariate ML analysis specific to the final cluster.

### —Experimental Validation and Illustration of Example Process—

Conventional time-domain clustering algorithms do poorly when the measured signals are contaminated with measurement noise. This is especially true when the noise becomes large enough that the noise is actually greater than the dynamics (changes in amplitude) in the measured signals. Time-domain clustering algorithms start making misidentifications—that is, placing wrong signals into wrong clusters—at noise ratios of standard deviation (STD)=1. Moreover, time-domain clustering algorithms become completely ineffective at noise ratios of STD=5. At noise ratios of STD=5 or higher, cluster assignments by time-domain clustering algorithms are no more accurate than random cluster assignments.

In one embodiment, the frequency-domain clustering techniques described herein overcome the challenges presented by noisy signals. In one embodiment, as demonstrated by experimental results described below, frequency-domain clustering as described herein robustly classifies signals into exactly correct clusters even at noise ratios of STD=10. Successful clustering under such high noise conditions is not possible using time-domain clustering algorithms.

To illustrate one example of a frequency-domain clustering method and demonstrate its effectiveness, the frequency-domain clustering method is applied to an example collection of time series signals. The collection of time series signals is synthesized or otherwise generated to include a set of three signal clusters that exhibit activity that is correlated within individual clusters, but not correlated across clusters. Because the signals are constructed to have the three clusters, there is ground-truth knowledge that the signals in the three clusters actually do possess cross correlation among the signals in each cluster, and lack cross correlation with any of the signals in the other two clusters.

Initially in the signal synthesis process, basis functions (having no random noise) are generated. The basis functions are dynamic in that they change in amplitude over time. In the basis functions, intra-group correlations (of the changes in amplitude) are very high, but the inter-group correlations are low. Three groups of signals are defined, and each group contains 10 signals. The periods of the sinusoid bases for each group are:
group 1:199, 383, and 547 observations;
group 2:163, 337, and 409 observations; and
group 3:139, 271, and 467 observations.

Group 1 contains signals indexed 1-10, group 2 contains signals indexed 11-20, and group 3 contains signals indexed 21-30. The example collection of time series signals thus includes thirty time series signals that belong, at a ground truth level, to three clusters or correlated groups.

For generality, the periods of the dynamic components in each signal are defined in terms of number of observations. For example, a period of 199 means there is a repeating pattern of change in amplitude every 199 observations. This is because in real industrial applications, signals can have sampling rates in milliseconds (or smaller) up though minutes (or larger). By defining periods in terms of number of observations, the results can be immediately turned into time-based periods for any industrial application by a simple scalar transformation to time units. In this example, the length of the time series signals is 4096 observations. 4096 observations is long enough to include several repetitions of even the longest period in the basis functions (547 observations).

To simulate the real-world challenges presented by measurement noise superimposed on the signals, Gaussian noise is applied to the basis functions to produce the example collection of time series signals. The noise blurs or otherwise obscures the intra-cluster and inter-cluster correlations of the signals. During the experiment, the noise ratios are systematically increased across all 3 clusters of signals to provide test signals at various levels of noise. For example, the tests were carried out with superimposed measurement noise with a standard deviation (STD) of 1 on top of all signals, followed by successively increasing the noise to STD levels of 2, 5, and 10.

The results of the frequency-domain clustering method with very high noise levels (STD=10) are summarized below to show how robust the frequency-domain clustering method is against noise. Similarly successful results were also obtained at lower noise levels. At each noise level, frequency-domain clustering method correctly separated the signals in the example collection into the clusters.

FIG. 4 illustrates a graph 400 of periodograms of selected signals from the example collection of signals. The noise on these signals has a standard deviation of 10. A periodogram for signal 1 405 and a periodogram for signal 5 410 of the example collection are shown plotted against a period axis 415 and an amplitude axis 420. Note that the underlying components or base functions having periods of 199, 383, and 547 are somewhat visible in the periodograms with peaks around these periods. But, the base functions are also somewhat obscured by the measurement noise superimposed on the underlying signals.

The influence of measurement noise is cleared away by computing the cross power spectral density (CPSD) between the signals. The CPSDs are then computed (for example as discussed above with reference to block 225 and block 320). FIG. 5 illustrates a graph 500 of the CPSD 505 of signals 1 and 5. CPSD 505 is plotted against a period axis 510 and an amplitude axis 515. As can be observed, the CPSD most clearly emphasizes the 3 frequency components. Clear peaks 520 are visible in CPSD 505 at the component periods of 199, 383, and 547. Other frequency components due to noise are suppressed in CPSD 505. Graph 500 demonstrates the better performance of CPSD to identify the signal characteristics compared to the noisy time series (not shown) and periodograms (such as periodograms 405 and 410).

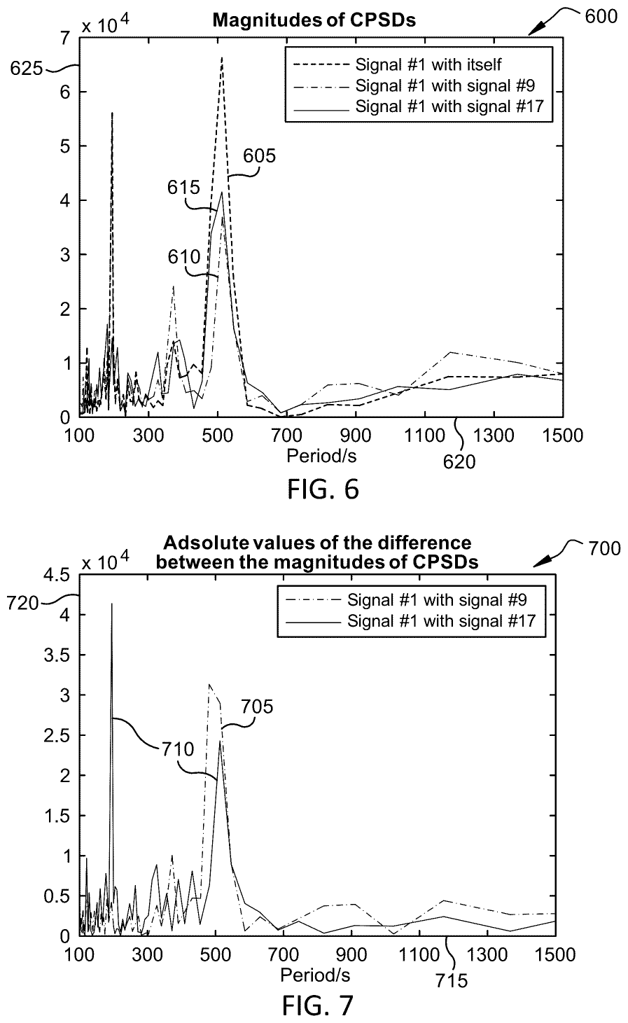

The CPSDs are then normalized by linear regression (for example as discussed above with reference to block 230 and block 325). The normalization places the CPSDs on the same scale as a periodogram of the reference signal to enable comparison. FIG. 6 illustrates a graph 600 of selected normalized CPSDs of pairs of signals. A CPSD 605 of signal 1 with itself, a CPSD 610 of signal 1 with signal 9, and a CPSD 615 of signal 1 with signal 17 are plotted against a period axis 620 and an amplitude axis 625. In one embodiment, CPSD 605 of signal 1 with itself is used as the periodogram of the reference signal, (that is, in one embodiment, the periodogram of the reference signal is the CPSD of the reference signal with itself). CPSD 610 of signal 1 with signal 9 and CPSD 615 of signal 1 with signal 17 are both normalized to the scale of CPSD 605 of signal 1 with itself.

The magnitudes of CPSD 605 for signal 1 with itself, CPSD 610 for signal 1 with signal 9 and CPSD 615 for signal 1 with signal 17 are shown in graph 600. Note that in ground truth, signal 1 and signal 9 belong to the same group or cluster, and signal 1 and signal 17 belong to different groups or clusters. While it may not be immediately visible in graph 600, the difference between the CPSD 610 for signal 1 with signal 9 and the CPSD 605 for signal 1 with itself is smaller than the difference between the CPSD 615 for signal 1 with signal 17 and the CPSD 605 for signal 1 with itself.

The differences become more visible in FIG. 7. FIG. 7 illustrates a graph 700 of the absolute value of difference (also referred to as absolute error) between periodogram of the reference signal 605 (CPSD 605 of signal 1 with itself) and selected CPSDs of signal pairs. Graph 700 shows absolute error 705 between the CPSD 610 for signal 1 with signal 9 and the periodogram of the reference signal 605. And, graph 700 shows absolute error 710 between the CPSD 615 for signal 1 with signal 17 and the periodogram of the reference signal 605. Absolute errors 705 and 710 are plotted against a period axis 715 and an amplitude axis 720. Absolute error 710 between signals belonging to different clusters is larger overall than absolute error 705 between signals belonging to the same cluster.

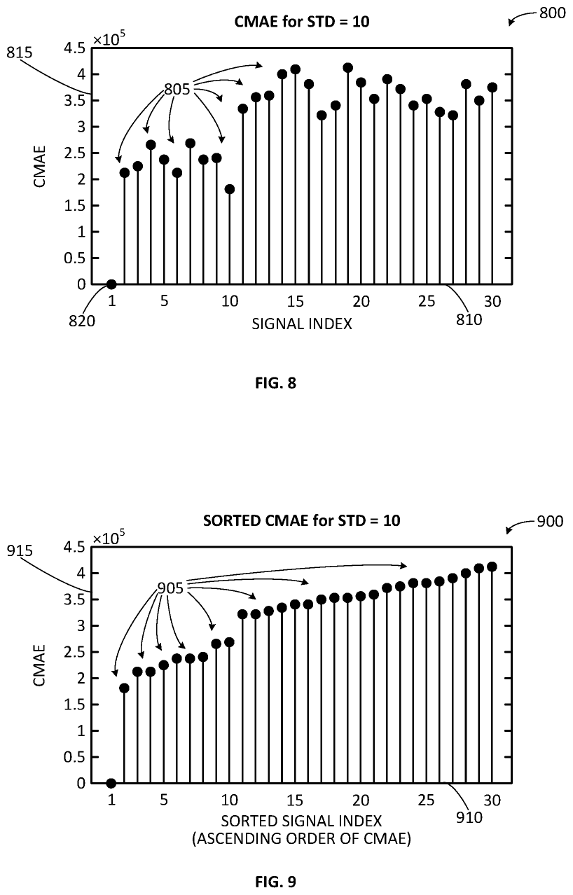

Cumulative mean absolute errors (CMAEs) are then calculated for the signals (for example as described above with reference to blocks 235 and 330). FIG. 8 illustrates a plot 800 of CMAE values 805 for the individual signals in the example collection. CMAE values 805 are plotted against a signal index axis 810 and a CMAE value axis 815. As indicated in plot 800, using signal 1 820 as a reference signal, the Cumulative Mean Absolute Errors (CMAEs) for signals indexed at 2 to 10 are smaller than the CMAEs for signal 1 and all of the other signals above 10. Thus these 9 signals (indexed 2 through 10) will be clustered into the same group as signal 1 by the frequency-domain clustering method, and signals indexed 1-10 will be removed from the example collection of signals that are available for clustering.

In one embodiment, the clustering process is enabled to be performed autonomously by the following steps of sorting by CMAE (for example as described at blocks 245 and 335), generation of a mean cumulative function (MCF) of the sorted CMAEs (for example as described at blocks 250 and 335), and detecting a change point in the MCF (for example as described at blocks 250 and 340).

In one embodiment, the signals are sorted by ascending value of CMAE. In other words, the CMAEs are sorted in ascending order, for example as discussed at blocks 245 and 335. FIG. 9 illustrates a plot 900 of CMAE values 905 for the individual signals in the example collection. The CMAE values 905 (and in one embodiment, the associated signals) have been sorted in ascending order of CMAE. Values sorted in ascending order of CMAE are re-ordered such that the CMAE increases with each succeeding signal. The CMAE values are plotted against a sorted signal index axis 910 and a CMAE value axis 915. The signal indexes in the sorted signal index axis 910 are reordered in the ascending order of CMAE, such that the reference signal with index 1 in plot 800 has index 1 in plot 900, the signal indexed 10 in plot 800 has index 2 in plot 900, the signal indexed 2 in plot 800 has index 3 in plot 900, the signal indexed 6 in plot 800 has index 4 in plot 900, the signal indexed 3 in plot 800 has index 5 in plot 900 and so on. The association between the original signal indexes and the reordered signal indexes is maintained in a data structure. For example, the sorted order of signals may be denoted by an index position in an array or other vector data structure, while the original signal index is a label applied to the signals, in whatever order they may appear in the vector data structure.

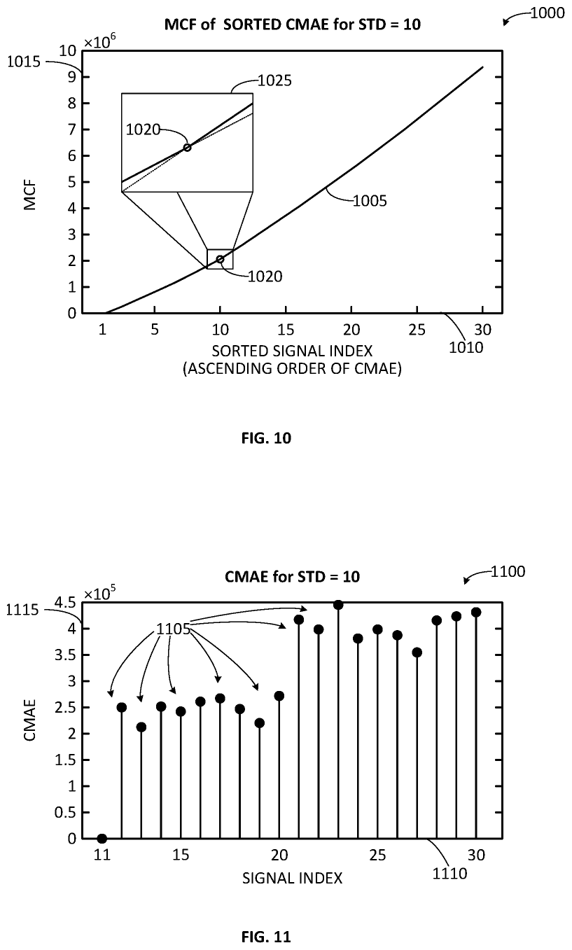

In one embodiment, a Mean Cumulative Function (MCF) for the sorted CMAEs is calculated (for example as described at blocks 250 and 335). In particular, the MCF is generated by cumulative summation of the sorted CMAEs. FIG. 10 illustrates a plot 1000 of the MCF 1005 for the CMAE values 905 in sorted order. The MCF 1005 is plotted against a sorted signal index axis 1010 and a MCF value axis 1015. As with signal index axis 910 above, signal index axis 1010 represents the sorted order of signals (by ascending value of CMAE), rather than the original signal index labels of the example collection.

In one embodiment, a change point detection algorithm analyzes the MCF to detect a change point that denotes a jump or discontinuity in the sorted CMAEs (for example, as discussed with reference to blocks 250 and 340). In one embodiment, the change point detection algorithm is a Mann-Kendall algorithm. For MCF 1005, a change point 1020 of the slope of the MCF 1005 is denoted by a circled point. A zoomed-in view 1025 shows that the change point detection algorithm detects even the subtle change in the slope of MCF 1005 at change point 1020. Below change point 1020, the slope of MCF 1005 is shallower, while beyond change point 1020, the slope of MCF 1005 is steeper. Where noise levels are lower, the change in slope of MCF is less subtle, and is instead more pronounced. Change point 1020 appears at the signal corresponding to the 10th smallest CMAE. The frequency-domain clustering method determines signals with CMAEs up to and including the change point to belong to one cluster. The 10 smallest CMAEs correspond to original signal index numbers 1, 10, 2, 6, 3, 5, 8, 9, 7, and 4, respectively. These signals are all in cluster 1, as is known from ground truth. Hence, the frequency-domain clustering method has defined a cluster correctly, despite the very high level of noise.

In one embodiment, the signals that are determined to be part of a cluster are extracted from the example collection and placed into the cluster, for example as described at blocks 240, 255, and 345. Thus, the 10 signals (assigned to cluster 1) are removed from the example collection of signals.

Any further clusters will be formed from the signals remaining in the example collection that have not been extracted. Thus, in one embodiment, the frequency-domain clustering method repeats using the remaining 20 signals and a new reference signal selected from the 20 remaining signals. In one embodiment, the first remaining signal, signal 11, is selected to be the reference signal. CMAEs are determined between the new reference signal (signal 11) and the remaining signals (including signal 11 itself). FIG. 11 illustrates a plot 1100 of the CMAE values 1105 for the remaining signals. CMAE values 1105 for the remaining signals are plotted against a signal index axis 1110 and a CMAE value axis 1115. CMAE values 1105 for the remaining signals are generated based on the new reference signal. Here, for the other 20 signals remaining, using the signal 11 as the reference signal, the CMAEs for signals indexed at 12 to 20 are visibly smaller than the signals indexed at 21-30. Thus these 9 signals indexed at 12 to 20 will be clustered autonomously are clustered into the same group as signal 11 by this iteration through the frequency-domain clustering method.

The CMAE values 1105 for the remaining signals are sorted in ascending order, for example as discussed above at blocks 245 and 335. FIG. 12 illustrates a plot 1200 of sorted CMAE values 1205. Sorted CMAE values 1205 have been sorted in ascending order of CMAE between CPSD of a signal and CPSD of the reference signal. Sorted CMAE values 1205 are plotted against a sorted signal index 1210 and a CMAE value index 1215. Sorted signal index axis 1210 represents the order of signals when sorted by ascending value of CMAE. There is a clear jump in CMAE following the signal at index 20. This will be detected by the frequency-domain clustering method using change point analysis of the MCF of the sorted CMAE values 1205 for the remaining signals.

The frequency-domain clustering method generates an MCF of the sorted CMAE values 1205 for the remaining signals. FIG. 13 illustrates a plot 1300 of the MCF 1305 of the sorted CMAE values 1205 for the remaining signals. The MCF 1305 is plotted against a sorted signal index axis 1310 and a MCF value axis 1315. Sorted signal index axis 1310 represents the order of signals when sorted by ascending value of CMAE. The frequency-domain clustering method executes a change point detection algorithm to detect change point 1320. The change point 1320 is found at signal index 20. The change point corresponds to the jump in CMAE following signal index 20 shown in plot 1200 of sorted CMAE values for the remaining signals. The change point at signal index 20 corresponds to the 10th smallest CMAE in the remaining signals. These 10 smallest CMAEs correspond to original signal index numbers 11, 13, 19, 15, 18, 12, 14, 16, 17, and 20, respectively. These signals are all in cluster 2 as is known from ground truth. The frequency-domain clustering method once again identified a cluster exactly correctly despite the very high noise on the signals. This second cluster is extracted from the example collection of time series signals, leaving signals 21-30 remaining.

Performing the frequency-domain clustering method for a further iteration will result in no detection of a change point for the remaining signals 21-30. Thus, the remaining signals 21-30 will be extracted into one final cluster, as described for example with reference to block 350. signals 21-30 are all in cluster 3 of the example collection, as is known from ground truth. In this way, the frequency-domain clustering method has exactly identified all clusters of intercorrelated activity in the example collection. The frequency-domain clustering method is therefore successful and completely accurate even though the noise level (noise STD=10) on the signals is so high as to render time-domain clustering impossible.

In one embodiment, this improvement in clustering effectiveness and accuracy of the frequency-domain clustering techniques shown and described herein is thus verified by accurate detection of known, ground truth clusters of signals in the presence of very high noise ratios (such as noise STD=10). While demonstrated using a relatively small example collection of signals, in one embodiment, the frequency-domain clustering techniques shown and described herein are scalable: frequency-domain clustering as shown and described herein is equally effective and accurate when applied to enormous datasets containing hundreds of thousands of signals. Differing noise ratios, differing sizes of signal sets, and differing numbers of clusters have been tested. In one embodiment, for each case, the frequency-domain clustering techniques shown and described herein show unprecedented accuracy for clustering even in the presence of very high uncertainty on the signals. For example, as shown above, the frequency-domain clustering technique achieves exact 100% clustering correctness even when the noise ratio is a factor of 10. No other clustering approach achieves this level of robustness to noise levels.

### —Mann-Kendall Analysis—

In the MK test, the data points are evaluated in sequence. Each data point is compared to all subsequent data points to determine whether the trend changes at that data point. At each data point, the value of a MK statistic is determined. As shown in EQ. 1, in one embodiment the MK statistic S for a number n of data points is given by

$$S = {\sum }_{i = 2}^{n} {\sum }_{j = 1}^{i - 1} sgn ( {x}_{i} - {x}_{j} ) \qquad EQ . 1$$

$$where :$$

$$sgn ( y ) = \{ \begin{matrix}- 1 , & y < 0 \\ 0 , & y = 0 \\ 1 , & y > 0\end{matrix}$$

The initial value of the MK statistic S is 0, indicating no trend. Where a data point from an earlier period xⱼ is larger than a data point from a later period xᵢ, the MK statistic S is decremented by 1. Where a data point from a later period xᵢ is larger than a data point from an earlier period xⱼ, the MK statistic S is incremented by 1. A positive value for the MK statistic S indicates an increasing trend, while a negative value for the MK statistic S indicates a decreasing trend.

In one embodiment, the change point in the sorted signals is detected at the data point (the signal index position among the sorted signals) where a confidence factor that a trend is present has satisfied a threshold. To determine confidence factors for the data points in the MCF, the frequency-domain clustering method 200 initially determines the variance of the MK statistic S. The variance of the MK statistic S, Var(S), is given by EQ. 2.

$$Var ( S ) = \frac{1}{18} ( n ( n - 1 ) ( 2 n + 5 ) - {\sum }_{k = 1}^{g} {t}_{k} ( {t}_{k} - 1 ) ( 2 {t}_{k} + 5 ) ) \qquad EQ . 2$$

where n is the number of data points (here, the number of signals remaining in the collection), k is the number of tied groups, and tₖ is the number of data points in the k^{th} tied group. (A “tied group” refers to a set of data points within the MCF that have the same value, or are in other words “tied” in magnitude, with neither value greater or less than the other.) The frequency-domain clustering method 200 gathers the values for the variables of EQ. 2 and executes EQ. 2 to generate the variance of the MK statistic Var(S).

Once the variance of the MK statistic Var(S) has been determined, frequency-domain clustering method 200 then generates a Z statistic that indicates how far the potential trend is from what would be expected if there is no trend. In one embodiment, the Z statistic is given by EQ. 3:

$$Z = \{ \begin{matrix}\frac{S - 1}{\sqrt{Var ( S )}} , & S > 0 \\ 0 , & S = 0 \\ \frac{S + 1}{\sqrt{Var ( S )}} , & S < 0\end{matrix} \qquad EQ . 3$$

The frequency domain clustering method 200 accesses the values of the MK statistic S, and the variance of the MK statistic Var(S), and executes EQ. 3 to generate the Z statistic.

Once the Z statistic is generated, the value of the Z statistic may be used to determine the probability of a false detection of a trend for the signal index position n. In one embodiment, the frequency-domain clustering method 200 may look up the probability of finding a change point where there is none (the value of p) for the position n in a table, such as a table of standard normal distribution probabilities indexed by Z statistic. Or, the frequency-domain clustering method 200 may calculate the value of p given the Z statistic using EQ. 4 for the probability distribution function of the standard normal distribution:

$$p ( Z ) = \frac{1}{\sqrt{2 π}} {e}^{- \frac{{Z}^{2}}{2}} \qquad EQ . 4$$

### —Overview of Multivariate ML Anomaly Detection—

In general, multivariate ML modeling techniques used for ML anomaly detection predict or estimate what each signal should be or is expected to be based on the other signals in a database or collection of time series signals. The predicted signal may be referred to as the “estimate”. A multivariate ML anomaly detection model is used to make the predictions or estimates for individual variables based on the values provided for other variables. For example, for Signal 1 in a database of N signals, the multivariate ML anomaly detection model will compute an estimate for Signal 1 using signals 2 through N.

In one embodiment, the ML anomaly detection model may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML anomaly detection model may be another form of algorithm used for multivariate anomaly detection, such as a neural network (NN), Support Vector Machine (SVM), or Linear Regression (LR). In one embodiment, the prognostic performance of the foregoing multivariate anomaly detection algorithms may be improved by application of the systems and methods described herein for frequency-domain clustering.

The ML anomaly detection model is trained to produce estimates of what the values of variables should be based on training with time series readings (such as time series vectors or time series signals) that represent normal or correct operation of a monitored asset. The training process involves iteratively optimizing a configuration of the ML model until the ML model consistently predicts expected values for the training portion of the individual signal that match (within an acceptable tolerance) the actual values of the training portion of the individual signal. To train the ML anomaly detection model, the time series readings are used to adjust the ML anomaly detection model. A configuration of correlation patterns between the variables of the ML anomaly detection model is automatically adjusted based on values of the time series readings so as to cause the ML anomaly detection model to produce accurate estimates for each variable based on inputs to other variables. Sufficient accuracy of estimates to conclude determine the ML anomaly detection model to be sufficiently trained may be determined by residuals being minimized below a pre-configured training threshold. A residual is a difference between an actual value (such as a measured, observed, sampled, or resampled value) and an estimate, reference, or prediction of what the value is expected to be. At the completion of training, the ML anomaly detection model has learned correlation patterns between variables.

Following training, the ML anomaly detection model may be used to monitor time series readings. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

For example, the presence of an anomaly may be detected by a sequential probability ratio test (SPRT) analysis of the residuals, as discussed in detail above. In one embodiment, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomaly is detected, and an alert indicating the anomaly may be generated.

### —Electronic Alerts—

In one embodiment, an electronic alert is generated by composing and transmitting a computer-readable message. The computer readable message may include content describing the anomaly that triggered the alert, such as a time when the anomaly was detected, an indication of the signal value that caused the anomaly, an identification of a cluster (and/or an underlying asset, component of the asset, or other source of the signals in the cluster) for which the anomaly occurred and the alert is applicable. In one embodiment, an electronic alert may be generated and sent in response to a detection of an anomalous signal value. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of an automated function in response to detection of an anomaly in a cluster. IN one embodiment, the automated function is configured to adjust the physical state or activity of the asset or component of the asset that is associated with the cluster, such as by triggering a maintenance response for or reduction of power to (e.g., slowdown or shutdown) the asset or component of the asset. In one embodiment, the electronic alert may be presented in a user interface such as a graphical user interface (GUI) by extracting the content of the electronic alert by a REST API that has received the electronic alert. The GUI may present a message, notice, or other indication that the status of operation of a specific machine, asset component, or other signal source has entered (or left) an anomalous state of operation.

In one embodiment, the automatic clustering method thus presents a technical solution that gathers unlabeled, noisy time series signals into clusters of correlated activity that are associated with particular activities or components of an asset and notifies users when an anomaly indicating degradation or incipient failure of the asset occurs, even where the level of noise on the signals is excessively high.

### —Cloud or Enterprise Embodiments—

In one embodiment, the present system (such as frequency-domain clustering system 100) is a computing/data processing system including a computing application or collection of distributed computing applications for access and use by other client computing devices that communicate with the present system over a network. In one embodiment, frequency-domain clustering system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, frequency-domain clustering system 100 is a centralized server-side application that provides at least the functions disclosed herein and that is accessed by many users by way of computing devices/terminals communicating with the computers of frequency-domain clustering system 100 (functioning as one or more servers) over a computer network. In one embodiment frequency-domain clustering system 100 may be implemented by a server or other computing device configured with hardware and software to implement the functions and features described herein.

In one embodiment, the components of frequency-domain clustering system 100 may be implemented as sets of one or more software modules executed by one or more computing devices specially configured for such execution. In one embodiment, the components of frequency-domain clustering system 100 are implemented on one or more hardware computing devices or hosts interconnected by a data network. For example, the components of frequency-domain clustering system 100 may be executed by network-connected computing devices of one or more computer hardware shapes, such as central processing unit (CPU) or general-purpose shapes, dense input/output (I/O) shapes, graphics processing unit (GPU) shapes, and high-performance computing (HPC) shapes.

In one embodiment, the components of frequency-domain clustering system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of frequency-domain clustering system 100 may (i) generate or compose an electronic message or signal to issue a command or request to another component, (ii) transmit the message or signal to other components of frequency-domain clustering system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by frequency-domain clustering system 100, for example through a web interface server. In one embodiment, the remote computing system may send requests to and receive responses from frequency-domain clustering system 100. In one example, access to the information or applications may be effected through use of a web browser on a personal computer or mobile device. In one example, communications exchanged with frequency-domain clustering system 100 may take the form of remote representational state transfer (REST) requests using JavaScript object notation (JSON) as the data interchange format for example, or simple object access protocol (SOAP) requests to and from XML servers. The REST or SOAP requests may include API calls to components of frequency-domain clustering system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

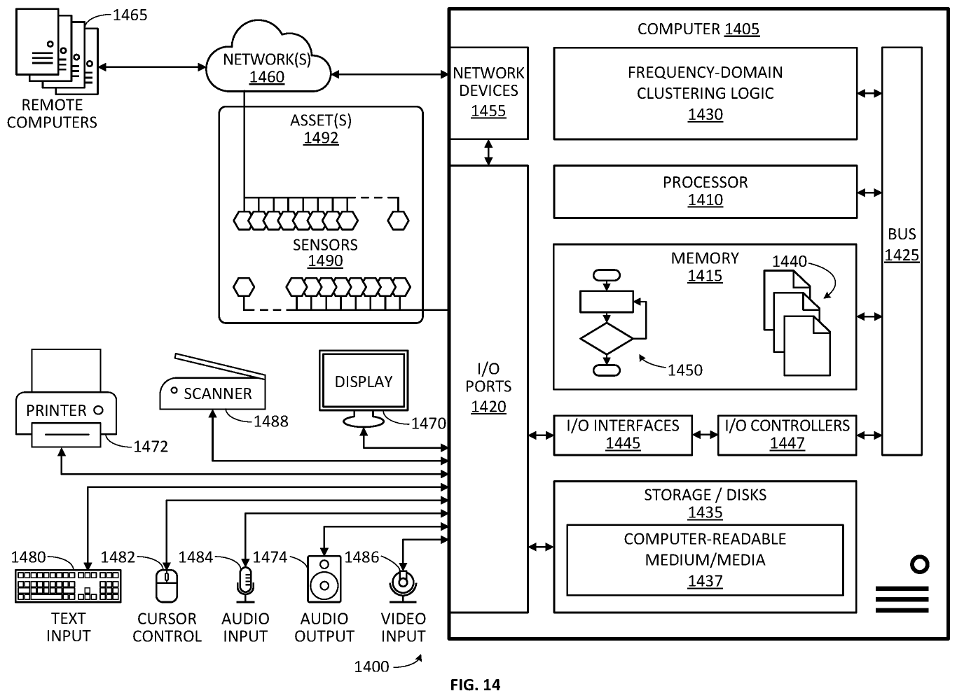

FIG. 14 illustrates an example computing system 1400 that is configured and/or programmed as a special purpose computing device with one or more of the example systems and methods described herein, and/or equivalents. The example computing device may be a computer 1405 that includes at least one hardware processor 1410, a memory 1415, and input/output ports 1420 operably connected by a bus 1425. In one example, the computer 1405 may include frequency-domain clustering logic 1430 configured to facilitate clustering of time series signals based on analysis in the frequency domain, similar to the frequency-domain clustering systems, methods and logic shown and described with reference to FIGS. 1-3.

In different examples, the logic 1430 may be implemented in hardware, one or more non-transitory computer-readable medium 1437 with stored instructions, firmware, and/or combinations thereof. While the logic 1430 is illustrated as a hardware component attached to the bus 1425, it is to be appreciated that in other embodiments, the logic 1430 could be implemented in the processor 1410, stored in memory 1415, or stored in disk 1435.

In one embodiment, logic 1430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate clustering of time series signals based on analysis in the frequency domain. The means may also be implemented as stored computer executable instructions that are presented to computer 1405 as data 1440 that are temporarily stored in memory 1415 and then executed by processor 1410.

Logic 1430 may also provide means (e.g., hardware, non-transitory computer-readable medium that stores executable instructions, firmware) for performing one or more of the disclosed functions and/or combinations of the functions.

Generally describing an example configuration of the computer 1405, the processor 1410 may be a variety of various processors including dual microprocessor and other multi-processor architectures. A memory 1415 may include volatile memory and/or non-volatile memory. Non-volatile memory may include, for example, ROM, PROM, and so on. Volatile memory may include, for example, RAM, SRAM, DRAM, and so on.

A storage disk 1435 may be operably connected to the computer 1405 via, for example, an input/output (I/O) interface (e.g., card, device) 1445 and an input/output port 1420 that are controlled by at least an input/output (I/O) controller 1447. The disk 1435 may be, for example, a magnetic disk drive, a solid-state disk drive, a floppy disk drive, a tape drive, a Zip drive, a flash memory card, a memory stick, and so on. Furthermore, the disk 1435 may be a CD-ROM drive, a CD-R drive, a CD-RW drive, a DVD ROM, and so on. The memory 1415 can store a process 1450 and/or a data 1440, for example. The disk 1435 and/or the memory 1415 can store an operating system that controls and allocates resources of the computer 1405.

The computer 1405 may interact with, control, and/or be controlled by input/output (I/O) devices via the input/output (I/O) controller 1447, the I/O interfaces 1445, and the input/output ports 1420. Input/output devices may include, for example, one or more displays 1470, printers 1472 (such as inkjet, laser, or 3D printers), audio output devices 1474 (such as speakers or headphones), text input devices 1480 (such as keyboards), cursor control devices 1482 for pointing and selection inputs (such as mice, trackballs, touch screens, joysticks, pointing sticks, electronic styluses, electronic pen tablets), audio input devices 1484 (such as microphones or external audio players), video input devices 1486 (such as video and still cameras, or external video players), image scanners 1488, video cards (not shown), disks 1406, network devices 1455, and so on. The input/output ports 1410 may include, for example, serial ports, parallel ports, and USB ports.

The computer 1405 can operate in a network environment and thus may be connected to the network devices 1455 via the I/O interfaces 1445, and/or the I/O ports 1420. Through the network devices 1455, the computer 1405 may interact with a network 1460. Through the network, the computer 1405 may be logically connected to remote computers 1465. Networks with which the computer 1405 may interact include, but are not limited to, a LAN, a WAN, and other networks.

In one embodiment, the computer 1405 may be connected to sensors 1490 through I/O ports 1420 or networks 1460 in order to receive information about physical states of monitored machines, devices, systems, facilities, or other apparatuses (collectively referred to as “assets” 1492) and components thereof. In one embodiment, sensors 1490 are configured to monitor physical phenomena occurring in or around an asset 1492. The assets 1492 generally include any type of machinery or facility with components that perform measurable activities. In one embodiment, sensors 1490 may be operably connected or affixed to assets 1492 or otherwise configured to detect and monitor physical phenomena occurring in or around the asset 1492. The sensors 1490 may produce time series signals of readings taken from the asset 1492. Assets 1492 may thus be considered to be sources of the signals (signal sources). The sensors 1490 may be network-connected sensors for monitoring any type of physical phenomena. Assets 1492 with network-connected sensors may be referred to as Internet of Things (IoT)-connected devices. The network connection of the sensors 1490 and networks 1460 may be wired or wireless.

In one embodiment, the sensors 1490 may include (but are not limited to): a temperature sensor (such as a thermocouple or resistive temperature detector), a vibration sensor (such as piezoelectric sensors), an accelerometer, a voltage sensor, a current sensor, a pressure sensor, a rotational speed sensor, a flow meter sensor, a speedometer or other speed sensor, an airspeed sensor or anemometer, a microphone, an electromagnetic radiation sensor, a proximity sensor, a gyroscope, an inclinometer, a global positioning system (GPS) sensor, a fuel gauge, a torque sensor, a flex sensor, a nuclear radiation detector, or any of a wide variety of other sensors or transducers for generating electrical signals that represent sensed physical phenomena, for example physical phenomena occurring in or around an asset.

In one embodiment, computer 1405 is configured with logic, such as software modules, to collect readings from sensors 1490 and store them as observations in a time series data structure such as a time series database. In one embodiment, the computer 1405 polls sensors 1490 to retrieve sensor telemetry readings. In one embodiment, the sensor telemetry readings may be a time series of vectors with sensed values for each of sensors 1490. In one embodiment, the computer 1405 passively receives sensor telemetry readings actively transmitted by sensors 1490. In one embodiment, the computer 1405 receives one or more collections, sets, or databases of sensor telemetry readings previously collected from sensors 1490, for example from storage 1435 or from remote computers 1465.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
accessing time series signals to be separated into clusters;
determining similarity of power spectral density among the time series signals;
extracting a cluster of similar time series signals from the time series signals based on the similarity of power spectral density; and
training a machine learning model to detect anomalies based on the cluster.

2. The computer-implemented method of claim 1, wherein determining similarity of power spectral density among the time series signals further comprises performing a comparison of the time series signals in a frequency domain.

3. The computer-implemented method of claim 1, wherein extracting a cluster of similar time series signals from the time series signals based on the similarity of power spectral density further comprises choosing those of the time series signals below a jump of dissimilarity to be the cluster of time series signals.

4. The computer-implemented method of claim 1, wherein determining similarity of power spectral density among the time series signals further comprises:
selecting one of the time series signals to be a reference signal;
generating cross power spectral densities between the reference signal and the other time series signals;
normalizing the cross power spectral densities to a periodogram of the reference signal; and
generating cumulative mean absolute errors of the normalized cross power spectral densities with respect to the periodogram of the reference signal, wherein the similarity of power spectral density is the cumulative mean absolute error of the cross power spectral density.

5. The computer-implemented method of claim 1, wherein extracting a cluster of similar time series signals from the time series signals based on the similarity of power spectral density further comprises:
sorting the time series signals based on the similarity of power spectral density of a time series signal with other time series signals;
detecting a change point in the similarities for the time series signals; and
selecting the time series signals below the change point to be in the cluster.

6. The computer-implemented method of claim 5, wherein the change point in the similarities for the time series signals is detected by applying a Mann-Kendall test to a mean cumulative function of the similarities in the sorted order of the time series signals.

7. The computer-implemented method of claim 5, wherein the steps of determining similarity of power spectral density and extracting a cluster of similar time series signals are repeated until no further change point is detected at a given confidence level, the method further comprising placing the remaining time series signals that were not extracted into a final cluster once no further change point is detected.

8. The computer-implemented method of claim 1, further comprising:
detecting an anomaly with the trained machine learning model; and
generating an electronic alert that the anomaly was detected in the cluster of the time series signals.

9. The computer-implemented method of claim 1, wherein noise on one or more of the time series signals is in excess of 50%.

10. The computer-implemented method of claim 1, wherein the machine learning model is a multivariate state estimation technique model, the method further comprising assigning the time series that are in the cluster to be inputs of the multivariate state estimation technique model, and not assigning the time series that are excluded from the cluster to be inputs of the multivariate state estimation technique model.

11. One or more non-transitory computer-readable media that includes stored thereon computer-executable instructions that when executed by at least a processor of a computer system cause the computer system to:
access a collection of time series signals that are undifferentiated with respect to clusters;
determine similarity in a frequency domain among the time series signals;
chooses a cluster of similar time series signals from the time series signals based on the similarity in the frequency domain; and
route the cluster to a destination that is discrete from destinations for other clusters detected in the time series signals.

12. The non-transitory computer-readable medium of claim 11, wherein the instructions for determining similarity of power spectral density among the time series signals further cause the computer system to perform a comparison of the time series signals in a frequency domain.

13. The non-transitory computer-readable medium of claim 11, wherein the instructions for choosing a cluster of similar time series signals from the time series signals based on the similarity in the frequency domain further cause the computer system to:
apply a Mann-Kendall test to detect a change point in the time series signals, wherein the time series signals are in sorted in order of similarity; and
choose those of the time series signals below the change point to be the cluster of time series signals.

14. The non-transitory computer-readable medium of claim 11, wherein the instructions further cause the computer system to:
repeat determining similarity in the frequency domain and extracting a cluster of similar time series signals until no further change point is detected at a given confidence level; and
place the remaining time series signals that were not extracted into a final cluster once no further change point is detected.

15. The non-transitory computer-readable medium of claim 10, wherein the instructions to route the cluster to a destination that is discrete from destinations for other clusters further cause the computer system to:
train a machine learning model to detect anomalies in the cluster, wherein the machine learning model is specific to the cluster;
monitor a surveillance phase of the cluster with the trained machine learning model to detect an anomaly; and
in response to detecting the anomaly, generate an electronic alert that the anomaly has occurred in the cluster.

16. A computer system, comprising:
at least one processor;
at least one memory connected to the at least one processor;
one or more non-transitory computer-readable media including instructions stored thereon that when executed by at least the processor cause the computing system to:
access a training range of time series signals that include unidentified clusters;
determine measures of correlation among the time series signals based on analysis in the frequency domain;
transfer time series signals into a cluster based on the measures of correlation;
train a machine learning model to detect anomalies based on the training range of the cluster; and
in response to detecting an anomaly in a surveillance range of the cluster, transmit an electronic alert that the anomaly has occurred in the cluster.

17. The computer system of claim 16, wherein the instructions for transferring time series signals into a cluster based on the measures of correlation further cause the computer system to:
sort the time series signals in ascending order of the measures of correlation; and
transfer into the cluster those of the time series signals having a measure of correlation below a discontinuity in the measures of correlation for the sorted time series signals.

18. The computer system of claim 16, wherein the measures of correlation among the time series signals are based on cumulative mean absolute errors of cross power spectral density between one of the time series signals that is selected as a reference and others of the time series signals.

19. The computer system of claim 16, wherein the machine learning model is a multivariate anomaly detection model.

20. The computer system of claim 16, further comprising:
an asset; and
one or more sensors that are configured to produce the time series signals as descriptions of physical states of the asset over time;
wherein the training range of the cluster describes a first physical state of the asset;
wherein the surveillance range of the cluster describes a second physical state of the asset; and
the anomaly in the surveillance range of the cluster indicates that a degradation of the asset is occurring.
